(19) United States
(12) Patent Application Publication
(10) Pub. No.: US 2026/0206019 A1
(43) Pub. Date: Jul. 16, 2026

(54) TECHNIQUES FOR ENABLING BANDWIDTH ADAPTION VIA GROUP-BASED DOWNLINK CONTROL INFORMATION

(71) Applicant: QUALCOMM Incorporated, San Diego, CA (US)

(72) Inventors: Diana MAAMARI, San Diego, CA (US); Gabi SARKIS, San Diego, CA (US)

(21) Appl. No.: 19/022,919

(22) Filed: Jan. 15, 2025

(51) Int. Cl. H04W 72/0457; H04L 1/00; H04W 72/231

(52) U.S. Cl. CPC H04W 72/0457; H04L 1/0004; H04W 72/231

(57) ABSTRACT

Methods, systems, and devices for wireless communications are described. In some cases, a user equipment (UE) may receive control signaling indicative of a configuration of a bandwidth part (BWP) and indicative of multiple sub-configurations associated with the BWP including a first sub-configuration associated with a first sub-portion of the BWP and a second sub-configuration associated with a second sub-portion of the BWP (e.g., different than the second sub-portion). The UE may additionally receive a group-based downlink control information (DCI) message indicative of which one of the first sub-configuration or the second sub-configuration is activated and may communicate, based on the group-based DCI message, one or more messages in accordance with activation of one of the first sub-configuration or the second sub-configuration.

### TECHNICAL FIELD

The following relates to wireless communications, including techniques for enabling bandwidth adaption via group-based downlink control information (DCI).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control signaling indicative of a configuration of a bandwidth part (BWP), receiving second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion, receiving a group-based downlink control information (DCI) message indicative of which one of the first sub-configuration or the second sub-configuration is activated, and communicating, based on the group-based DCI message, one or more messages in accordance with activation of one of the first sub-configuration or the second sub-configuration.

A UE for wireless communications is described. The UE may include one or more memories storing processor executable code, and one or more processors coupled with the one or more memories. The one or more processors may individually or collectively be operable to execute the code to cause the UE to receive first control signaling indicative of a configuration of a BWP, receive second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion, receive a group-based DCI message indicative of which one of the first sub-configuration or the second sub-configuration is activated, and communicate, based on the group-based DCI message, one or more messages in accordance with activation of one of the first sub-configuration or the second sub-configuration.

Another UE for wireless communications is described. The UE may include means for receiving first control signaling indicative of a configuration of a BWP, means for receiving second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion, means for receiving a group-based DCI message indicative of which one of the first sub-configuration or the second sub-configuration is activated, and means for communicating, based on the group-based DCI message, one or more messages in accordance with activation of one of the first sub-configuration or the second sub-configuration.

A non-transitory computer-readable medium storing code for wireless communications is described. The code may include instructions executable by one or more processors to receive first control signaling indicative of a configuration of a BWP, receive second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion, receive a group-based DCI message indicative of which one of the first sub-configuration or the second sub-configuration is activated, and communicate, based on the group-based DCI message, one or more messages in accordance with activation of one of the first sub-configuration or the second sub-configuration.

In some examples of the method, UEs, and non-transitory computer-readable medium described herein, the first sub-configuration may be associated with a first operational state, the second sub-configuration may be associated with a second operational state, and the group-based DCI message may be indicative of which one of the first sub-configuration or the second sub-configuration may be activated based on the group-based DCI message being indicative of the first operational state or the second operational state.

In some examples of the method, UEs, and non-transitory computer-readable medium described herein, the group-based DCI message may be indicative of which one of the first sub-configuration or the second sub-configuration may be activated based on the group-based DCI message being indicative of a first index associated with the first sub-configuration, a second index associated with the second sub-configuration, or both.

Some examples of the method, UEs, and non-transitory computer-readable medium described herein may further include operations, features, means, or instructions for receiving an indication of table including associations between the set of multiple sub-configurations and a set of multiple indexes, including at least the first index and the second index.

In some examples of the method, UEs, and non-transitory computer-readable medium described herein, the one or more messages may be communicated at a first time and a duration between a last symbol of a downlink control channel carrying the group-based DCI message and the first time satisfies a threshold duration.

In some examples of the method, UEs, and non-transitory computer-readable medium described herein, the threshold duration may be based on a retuning capability of the UE.

Some examples of the method, UEs, and non-transitory computer-readable medium described herein may further include operations, features, means, or instructions for transmitting a feedback message in response to the group-based DCI message, where communicating the one or more messages may be based on transmission of the feedback message.

In some examples of the method, UEs, and non-transitory computer-readable medium described herein, the group-based DCI message may be indicative of which one of the first sub-configuration or the second sub-configuration may be activated for uplink, which one of the first sub-configuration or the second sub-configuration may be activated for downlink, or both.

In some examples of the method, UEs, and non-transitory computer-readable medium described herein, each of the first sub-configuration and the second sub-configuration may be common to uplink and downlink.

In some examples of the method, UEs, and non-transitory computer-readable medium described herein, the group-based DCI message may be indicative of which one of the first sub-configuration or the second sub-configuration may be activated based on the group-based DCI message being indicative of which one of the first sub-configuration or the second sub-configuration may be activated, based on the group-based DCI message being indicative of which one of the first sub-configuration or the second sub-configuration may be deactivated, or both.

In some examples of the method, UEs, and non-transitory computer-readable medium described herein, the BWP may be associated with a set of multiple resource blocks (RBs) and the set of multiple RBs includes a first set of RBs associated with the first sub-portion and a second set of RBs associated with the second sub-portion.

In some examples of the method, UEs, and non-transitory computer-readable medium described herein, the group-based DCI message may be indicative of which one of the first sub-configuration or the second sub-configuration may be activated based on the group-based DCI message being indicative of which of the first set of RBs or the second set of RBs may be activated, which of the first set of RBs or the second set of RBs may be deactivated, or both.

In some examples of the method, UEs, and non-transitory computer-readable medium described herein, the BWP may be associated with a set of multiple layers and the set of multiple layers includes a first set of layers associated with the first sub-portion and a second set of layers associated with the second sub-portion.

In some examples of the method, UEs, and non-transitory computer-readable medium described herein, the group-based DCI message may be indicative of which one of the first sub-configuration or the second sub-configuration may be activated based on the group-based DCI message being indicative of which of the first set of layers or the second set of layers may be activated, which of the first set of layers or the second set of layers may be deactivated, or both.

In some examples of the method, UEs, and non-transitory computer-readable medium described herein, the BWP may be associated with a set of multiple modulation and coding schemes (MCSs) and the set of multiple MCSs includes a first set of MCSs associated with the first sub-portion and a second set of MCSs associated with the second sub-portion.

In some examples of the method, UEs, and non-transitory computer-readable medium described herein, the group-based DCI message may be indicative of which one of the first sub-configuration or the second sub-configuration may be activated based on the group-based DCI message being indicative of which of the first set of MCSs or the second set of MCSs may be activated, which of the first set of MCSs or the second set of MCSs may be deactivated, or both.

A method for wireless communications by a network entity is described. The method may include transmitting first control signaling indicative of a configuration of a BWP, transmitting second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion, transmitting a group-based DCI message indicative of which one of the first sub-configuration or the second sub-configuration is activated, and communicating, based on the group-based DCI message, one or more messages in accordance with activation of one of the first sub-configuration or the second sub-configuration.

A network entity for wireless communications is described. The network entity may include one or more memories storing processor executable code, and one or more processors coupled with the one or more memories. The one or more processors may individually or collectively be operable to execute the code to cause the network entity to transmit first control signaling indicative of a configuration of a BWP, transmit second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion, transmit a group-based DCI message indicative of which one of the first sub-configuration or the second sub-configuration is activated, and communicate, based on the group-based DCI message, one or more messages in accordance with activation of one of the first sub-configuration or the second sub-configuration.

Another network entity for wireless communications is described. The network entity may include means for transmitting first control signaling indicative of a configuration of a BWP, means for transmitting second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion, means for transmitting a group-based DCI message indicative of which one of the first sub-configuration or the second sub-configuration is activated, and means for communicating, based on the group-based DCI message, one or more messages in accordance with activation of one of the first sub-configuration or the second sub-configuration.

A non-transitory computer-readable medium storing code for wireless communications is described. The code may include instructions executable by one or more processors to transmit first control signaling indicative of a configuration of a BWP, transmit second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion, transmit a group-based DCI message indicative of which one of the first sub-configuration or the second sub-configuration is activated, and communicate, based on the group-based DCI message, one or more messages in accordance with activation of one of the first sub-configuration or the second sub-configuration.

In some examples of the method, network entities, and non-transitory computer-readable medium described herein, the first sub-configuration may be associated with a first operational state, the second sub-configuration may be associated with a second operational state, and the group-based DCI message may be indicative of which one of the first sub-configuration or the second sub-configuration may be activated based on the group-based DCI message being indicative of the first operational state or the second operational state.

In some examples of the method, network entities, and non-transitory computer-readable medium described herein, the group-based DCI message may be indicative of which one of the first sub-configuration or the second sub-configuration may be activated based on the group-based DCI message being indicative of a first index associated with the first sub-configuration, a second index associated with the second sub-configuration, or both.

Some examples of the method, network entities, and non-transitory computer-readable medium described herein may further include operations, features, means, or instructions for transmitting an indication of table including associations between the set of multiple sub-configurations and a set of multiple indexes, including at least the first index and the second index.

In some examples of the method, network entities, and non-transitory computer-readable medium described herein, the one or more messages may be communicated at a first time and a duration between a last symbol of a downlink control channel carrying the group-based DCI message and the first time satisfies a threshold duration.

In some examples of the method, network entities, and non-transitory computer-readable medium described herein, the threshold duration may be based on a retuning capability of a UE.

Some examples of the method, network entities, and non-transitory computer-readable medium described herein may further include operations, features, means, or instructions for receiving a feedback message in response to the group-based DCI message, where communication of the one or more messages may be based on transmission of the feedback message.

In some examples of the method, network entities, and non-transitory computer-readable medium described herein, the group-based DCI message may be indicative of which one of the first sub-configuration or the second sub-configuration may be activated for uplink, which one of the first sub-configuration or the second sub-configuration may be activated for downlink, or both.

In some examples of the method, network entities, and non-transitory computer-readable medium described herein, each of the first sub-configuration and the second sub-configuration may be common to uplink and downlink.

In some examples of the method, network entities, and non-transitory computer-readable medium described herein, the group-based DCI message may be indicative of which one of the first sub-configuration or the second sub-configuration may be activated based on the group-based DCI message being indicative of which one of the first sub-configuration or the second sub-configuration may be activated, based on the group-based DCI message being indicative of which one of the first sub-configuration or the second sub-configuration may be deactivated, or both.

In some examples of the method, network entities, and non-transitory computer-readable medium described herein, the BWP may be associated with a set of multiple RBs and the set of multiple RBs includes a first set of RBs associated with the first sub-portion and a second set of RBs associated with the second sub-portion.

In some examples of the method, network entities, and non-transitory computer-readable medium described herein, the group-based DCI message may be indicative of which one of the first sub-configuration or the second sub-configuration may be activated based on the group-based DCI message being indicative of which of the first set of RBs or the second set of RBs may be activated, which of the first set of RBs or the second set of RBs may be deactivated, or both.

In some examples of the method, network entities, and non-transitory computer-readable medium described herein, the BWP may be associated with a set of multiple layers and the set of multiple layers includes a first set of layers associated with the first sub-portion and a second set of layers associated with the second sub-portion.

In some examples of the method, network entities, and non-transitory computer-readable medium described herein, the group-based DCI message may be indicative of which one of the first sub-configuration or the second sub-configuration may be activated based on the group-based DCI message being indicative of which of the first set of layers or the second set of layers may be activated, which of the first set of layers or the second set of layers may be deactivated, or both.

In some examples of the method, network entities, and non-transitory computer-readable medium described herein, the BWP may be associated with a set of multiple MCSs and the set of multiple MCSs includes a first set of MCSs associated with the first sub-portion and a second set of MCSs associated with the second sub-portion.

In some examples of the method, network entities, and non-transitory computer-readable medium described herein, the group-based DCI message may be indicative of which one of the first sub-configuration or the second sub-configuration may be activated based on the group-based DCI message being indicative of which of the first set of MCSs or the second set of MCSs may be activated, which of the first set of MCSs or the second set of MCSs may be deactivated, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for enabling bandwidth adaption via group-based downlink control information (DCI) in accordance with one or more aspects of the present disclosure.

FIG. 2 shows an example of a wireless communications system that supports techniques for enabling bandwidth adaption via group-based DCI in accordance with one or more aspects of the present disclosure.

FIG. 3 shows examples of configuration diagrams that supports techniques for enabling bandwidth adaption via group-based DCI in accordance with one or more aspects of the present disclosure.

FIG. 4 shows an example of a process flow that supports techniques for enabling bandwidth adaption via group-based DCI in accordance with one or more aspects of the present disclosure.

FIGS. 5 and 6 show block diagrams of devices that support techniques for enabling bandwidth adaption via group-based DCI in accordance with one or more aspects of the present disclosure.

FIG. 7 shows a block diagram of a communications manager that supports techniques for enabling bandwidth adaption via group-based DCI in accordance with one or more aspects of the present disclosure.

FIG. 8 shows a diagram of a system including a device that supports techniques for enabling bandwidth adaption via group-based DCI in accordance with one or more aspects of the present disclosure.

FIGS. 9 and 10 show block diagrams of devices that support techniques for enabling bandwidth adaption via group-based DCI in accordance with one or more aspects of the present disclosure.

FIG. 11 shows a block diagram of a communications manager that supports techniques for enabling bandwidth adaption via group-based DCI in accordance with one or more aspects of the present disclosure.

FIG. 12 shows a diagram of a system including a device that supports techniques for enabling bandwidth adaption via group-based DCI in accordance with one or more aspects of the present disclosure.

FIGS. 13 and 14 show flowcharts illustrating methods that support techniques for enabling bandwidth adaption via group-based DCI in accordance with one or more aspects of the present disclosure.

### DETAILED DESCRIPTION

Some wireless communications may support bandwidth part (BWP) switching. That is, a user equipment (UE) may receive, from a network entity, control signaling (e.g., radio resource control (RRC) signaling) configuring the UE for communications via a first BWP (e.g., within a BW) and, at a later time, may receive, from the network entity, additional control signaling indicating for the UE to switch from the first BWP to a second BWP (e.g., within the BW), where, in some cases, the first BWP and the second BWP may be different sizes. For example, the first BWP may be smaller in size (e.g., 20 megahertz (MHz)) than the second BWP (e.g., 100 MHz), such that the UE may receive the additional control signaling indicating the BWP switch when the network entity is to transmit data of a size greater than a threshold (e.g., large data) is to be transmitted. However, due to one or more other configurations (e.g., operational parameters, communication parameters) of the UE being dependent on BWP, switching BWPs may result in increased latency due to reconfiguration of the UE based on a BWP switch. Accordingly, in some cases, the UE may support light BWP adaption (e.g., light adaption) in which the network entity may indicate, to the UE, a change in BWP (e.g., BWP adaption) via one or more scheduling restrictions. For example, rather than indicating a switch from the second BWP to the first BWP (e.g., a larger BWP to a smaller BWP), the network entity may restrict the BW of the UE to the first BWP (e.g., indicate a restriction on a portion of the BW that is not part of the first BWP), thus reducing latency by enabling the UE to avoid reconfiguration of the UE based on the change in active BW. However, conventional techniques for light BWP adaption may be deficient.

Accordingly, techniques described herein may enable dynamic sub-BWP switching via group-based downlink control information (DCI). For example, a UE may receive an indication of a configuration of a BWP and may additionally receive an indication of multiple sub-configurations of the BWP, such as a first sub-configuration associated with a first sub-BWP (e.g., a first portion of the BWP) and a second sub-configuration associated with a second sub-BWP (e.g., a second portion of the BWP). In such cases, each sub-BWP may be associated with a set of resource blocks (RBs) (e.g., from a maximum quantity of RBs associated with the BWP), a set of layers (e.g., from a maximum quantity of layers associated with the BWP), a set of modulation and coding schemes (MCSs) (e.g., from a maximum quantity of MCSs associated with the BWP), or any combination thereof. Thus, the network entity may transmit, to the UE, a group-based DCI indicating which sub-configuration (e.g., or sub-configurations) is activated, deactivated, or both. For example, the group-based DCI may indicate which set of RBs, which set of layers, which set of MCSs, or any combination thereof, are activated, which set of RBs, which set of layers, which set of MCSs, or any combination thereof, are deactivated, or both.

Aspects of the disclosure are initially described in the context of wireless communications systems. Aspects of the disclosure are then described in the context of resource configurations and a process flow. Aspects of the disclosure are further illustrated by and described with reference to apparatus diagrams, system diagrams, and flowcharts that relate to techniques for enabling bandwidth adaption via group-based DCI.

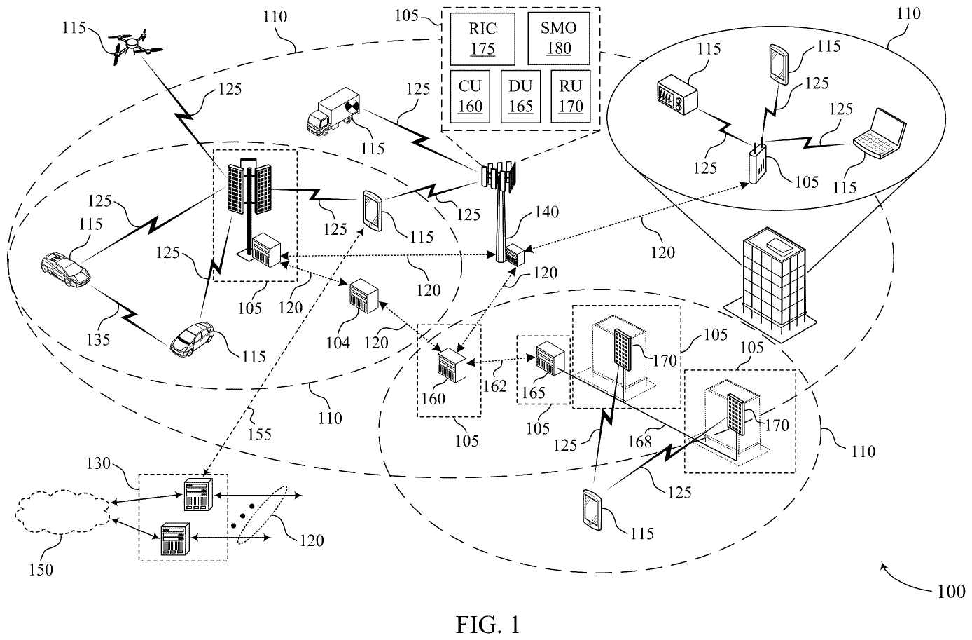

FIG. 1 shows an example of a wireless communications system 100 that supports techniques for enabling bandwidth adaption via group-based DCI in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3 ), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for enabling bandwidth adaption via group-based DCI as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a BWP) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for

### Communications With a Ue 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023). Each frame may include multiple consecutively-numbered subframes or

slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation. A subframe, a slot, a mini-slot, or a symbol may be the smallest scheduling

unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, UEs 115 of the wireless communications system 100 may support multiple methods of changing one or more communication (e.g., operational) parameters at a UE 115. For example, in some cases, a network entity 105 may perform full RRC reconfiguration of the UE 115, which may result in the UE 115 performing reconfiguration when a change in, BW, quantity of downlink or uplink layers, antennas, search space periodicity, or any combination thereof, is indicated by the network entity 105-a. In another example, the network entity 105 may indicate a full BWP switch to the UE 115 via DCI, which may result in the UE 115 performing reconfiguration when a change in, BW, quantity of downlink or uplink layers, antennas, search space periodicity, or any combination thereof, is indicated by the network entity 105-a (e.g., via the BWP switch). In another example, the network entity 105 may perform DCI-based adaption (e.g., such as search space set group (SSSG) switching), which may result in the UE 115 performing reconfiguration when MCS, BW, layers, antennas, or any combination thereof, is indicated by the network entity 105-a (e.g., via the DCI-based adaption).

In some cases, the wireless communications system 100 may support techniques to enable dynamic sub-BWP switching via group-based DCI. For example, a UE 115 may receive, from a network entity 105, an indication of a configuration of a BWP and may additionally receive, from the network entity 105, an indication of multiple sub-configurations of the BWP (e.g., one or more sub-configurations for downlink, one or more sub-configurations for uplink, one or more sub-configurations common to uplink and downlink, or any combination thereof), such as a first sub-configuration associated with a first sub-BWP (e.g., first sub-band, a first RB set, a first portion of the BWP) and a second sub-configuration associated with a second sub-BWP (e.g., a second sub-band, a second RB set, a second portion of the BWP). In such cases, each sub-BWP may be associated with a set of resource blocks (RBs) (e.g., from a maximum quantity of RBs associated with the BWP), a set of layers (e.g., from a maximum quantity of layers associated with the BWP), a set of modulation and coding schemes (MCSs) (e.g., from a maximum quantity of MCSs associated with the BWP), or any combination thereof. Thus, the network entity 105 may transmit, to the UE 115, a group-based DCI indicating which sub-configuration (e.g., or sub-configurations) is activated, deactivated, or both. For example, the group-based DCI may indicate which sets of RBs (e.g., sub-BWPs, sub-bands), which sets of downlink and uplink layers (e.g., from maximum rank), which sets of MCSs (e.g., from a maximum configured MCS or MCS table), which sets of SSSGs, or any combination thereof, are activated (e.g., or valid) and, consequently (e.g., implicitly), which sets of RBs, which sets of downlink and uplink layers, which sets of MCSs, which sets of SSSGs, or any combination thereof, are deactivated.

In some examples, the signaling can be sequence group-based signaling.

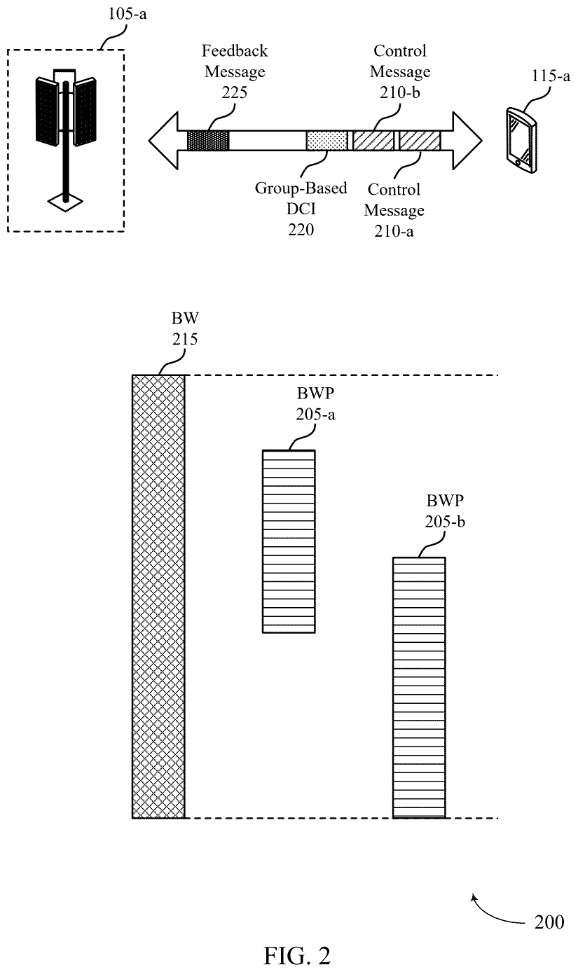

FIG. 2 shows an example of a wireless communications system 200 that supports techniques for enabling bandwidth adaption via group-based DCI in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

Some wireless communications systems, such as the wireless communications system 200, may support BWPs 205 (e.g., within a BW 215) to enable fast and low-signaling overhead adaption of one or more communication parameters (e.g., as compared to not supporting BWPs 205). That is, multiple communication parameters (e.g., RRC parameters) may be organized, or grouped, into sets, where each set corresponds to a BWP 205 and may be referred to as a BWP container (e.g., BWPs 205 may function as profiles). Thus, when a BWP switch (e.g., change) occurs (e.g., an active BWP 205 changes), such as from a BWP 205-a to a BWP 205-b, a wireless device, such as the UE 115-a, may switch from a first set of communication parameters associated with the BWP 205-a to a second set of communication parameters associated with the BWP 205-b (e.g., simplified switching of communication parameters that impact UE power consumption).

In some cases, a BWP switch may occur based on a network entity 105, such as the network entity 105-a, transmitting, to the UE 115-a, RRC signaling or DCI signaling indicative of the BWP switch. For example, the UE 115-a may receive, from the network entity 105-a, RRC signaling configuring the UE 115-a for communications via the BWP 205-a and, at a later time, may receive, from the network entity 105-a, second RRC signaling indicating for the UE 115-a to switch from the BWP 205-a to the BWP 205-b. In some cases, the BWP 205-a may be smaller in size (e.g., 20 MHz) than the second BWP (e.g., 100 MHz), such that the UE 115-a may receive the additional control signaling indicating the BWP switch when the network entity 105-a is to transmit (e.g., is to schedule) data of a size greater than a threshold (e.g., large data). Additionally, or alternatively, a BWP switch may occur based on expiration of a BWP inactivity timer. For example, the BWP 205-b may be associated with an inactivity timer that is activated based on reception of the additional control signaling and if no activity occurs on the BWP 205-b during a duration of the inactivity timer, the inactivity timer may expire, resulting in the UE 115-a switching from the BWP 205-b back to the BWP 205-a (e.g., a smaller BWP 205).

However, due to one or more other configurations (e.g., communication parameters) of the UE 115-a being dependent on an active BWP 205 (e.g., being BWP-dependent), switching BWPs 205 may result in increased latency due to reconfiguration of the UE 115-a (e.g., hardware and software) based on a BWP switch. That is, in the latter case, a timeline associated with a BWP switch may include radio frequency (RF) retuning, baseband (BB) clock retuning, reconfiguration of the UE 115-a, or any combination thereof, where a duration associated with the RF retuning and BB clock retuning may be less than a duration associated with the reconfiguration of the UE 115-a. For example, to switch from a low RF, low BB power state to a high RF, high BB power state, the switching timeline may include 1 slot in which the UE 115-a performs the RF retuning and BB clock retuning (e.g., setting) plus 4 additional slots in which the UE 115-a performs a reconfiguration procedure (e.g., reconfigures the UE 115-a).

That is, while BWP switching may enable the network entity 105-a to change, or switch, multiple (e.g., a large quantity) communication parameters, BWP switching results in a change in configuration of the UE 115-a, resulting in increased latency associated with reconfiguration of the UE 115-a. For example, DCI size, DCI format, DCI field sizes, SS, control resource set (CORESET), or any combination thereof may be affected by a BWP switch. Additionally, or alternatively, misalignment of communication parameters (e.g., configurations) between the UE 115-a and the network entity 105-a may result in UE 115-a being unreachable for a duration. Other adaption mechanisms, such as SSSG switching may result in similar outcomes as BWP switching.

Accordingly, in some cases, the wireless communications system 200 may support a form of BWP adaption associated with a shorter application time (e.g., shorter switching timeline dependent on RF retuning and BB retuning), a smaller quantity of registers that may be reconfigured on the UE 115-a, a reduction in the impact of misalignment between the UE 115-a and the network entity 105-a (e.g., control messages 210 to the UE 115-a may remain decodable even if an indication is missed or a false detection occurs), or any combination thereof, which may be referred to as light BWP adaption. For light BWP adaption, signaling may remain unaffected (e.g., as compared to BWP switching), but the BWP adaption may occur via scheduling restrictions. That is, the UE 115-a may be configured with the BW 215 (e.g., a maximum, or threshold, BW 215), but rather than indicating a switch from a first BWP 205, such as the BWP 205-a, to a second BWP 205, such as the BWP 205-b, the network entity 105-a may restrict the BW 215 (e.g., RF bandwidth) of the UE 115-a to the BWP 205-b (e.g., indicate a restriction on a portion of the BW 215 that is not part of the BWP 205-b), thus reducing latency by enabling the UE 115-a to avoid reconfiguration of the UE 115-a (e.g., light BWP adaption may be light-weight and fast, thus enabling the network entity 105-a to trigger light BWP adaption more dynamically than BWP switching depending on traffic demand).

Additionally, or alternatively, instead of BWP switching to enable larger Quadrature Amplitude Modulation (QAM) schemes, such as 1K QAM, the network entity 105-a may refrain from changing an MCS table and may refrain from scheduling 1K QAM entries (e.g., apply scheduling restrictions to a maximum MCS). Similarly, instead of BWP switching to enable a larger quantity of layers, the network entity 105-a may support restriction of a subset of a total quantity of layers supported by the UE 115-a (e.g., apply scheduling restrictions to a maximum rank). For example, the UE 115-a may support a threshold (e.g., maximum) rank of 4, however, the network entity 105-a may indicate, to the UE 115-a, that the network entity 105-a may not schedule with rank 4 for a threshold duration. Similarly, the UE 115-a may support an active BWP 205 of 100 MHz, however, the network entity 105-a may indicate, to the UE 115-a, that the network entity 105-a may not schedule beyond 20 MHz. However, conventional techniques for indicating scheduling restrictions for light BWP adaption may be deficient.

Accordingly, techniques described herein may enable dynamic sub-BWP switching via group-based (e.g., group-common) DCI 220. For example, the UE 115-a may receive, from the network entity 105-a, a control message 210-a (e.g., RRC message) indicative of a configuration associated with a BWP 205 (e.g., a limited BWP 205 within the BW 215) and a control message 210-b (e.g., the same control message 210 or a different control message 210 as the control message 210-a) indicative of multiple sub-configurations associated with the BWP 205. For example, the multiple sub-configurations may include a first sub-configuration associated with a first sub-BWP (e.g., a first portion of the BWP 205) and a second sub-configuration associated with a second sub-BWP (e.g., a second portion of the BWP 205).

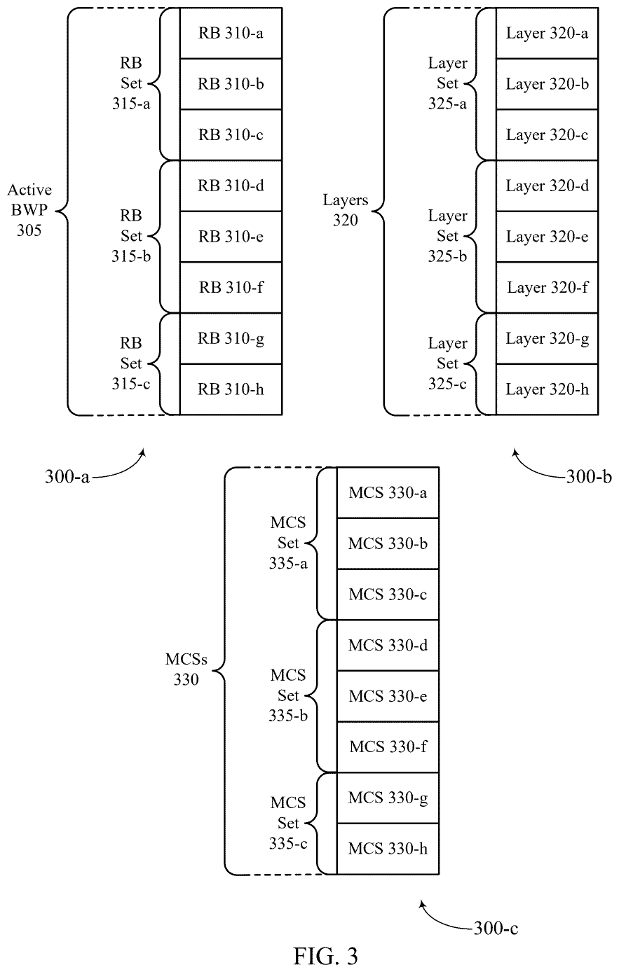

In such cases, each sub-BWP may be associated with a respective set of RBs (e.g., from a maximum quantity of RBs associated with, or configured for, the BWP 205), a respective set of layers, or antennas, (e.g., from a maximum quantity of layers associated with, or configured for, the BWP 205), a respective set of MCSs (e.g., from a maximum quantity of MCSs associated with, or configured for, the BWP 205), or any combination thereof, as described further with reference to FIG. 3. For example, the first sub-configuration may be associated with a first set of RBs, a first set of layers, a first set of MCSs, or any combination thereof, and the second sub-configuration may be associated with a second set of RBs, a second set of layers, a second set of MCSs, or any combination thereof.

Thus, the network entity 105-a may transmit, to the UE 115-a, group-based DCI 220 (e.g., a group-based DCI message) indicating which sub-configuration (e.g., which set of RBs, which set of layers, which set of MCSs, or any combination thereof) is activated, which sub-configuration is deactivated, or both. In other words, the network entity 105-a may indicate a scheduling restriction for the BWP 205 via the group-based DCI 220. For example, the group-based DCI 220 may indicate that the first sub-configuration is activated, the second sub-configuration is deactivated, or both, such that the UE 115-a may communicate (e.g., may expect to be scheduled) in accordance with (e.g., via) the first set of RBs, the first set of layers (e.g., antennas), the first set of MCSs, or any combination thereof, and may refrain from communicating (e.g., may be restricted from communication, may not expect to be scheduled) in accordance with (e.g., via) the second set of RBs, the second set of layers, the second set of MCSs, or any combination thereof.

In some cases, the group-based DCI 220 may indicate (e.g., explicitly) which sub-configuration (e.g., or sub-configurations) is activated and which sub-configuration (e.g., or sub-configurations) is deactivated. For example, the group-based DCI 220 may indicate that the first sub-configuration is activated and the second sub-configuration is deactivated. In some other examples, the group-based DCI 220 may indicate either which sub-configuration (e.g., or sub-configurations) is activated or which sub-configuration (e.g., or sub-configurations) is deactivated. For example, the group-based DCI 220 may indicate, explicitly, that the first sub-configuration is activated, such that the UE 115-a may infer, or determine, that the second sub-configuration is deactivated based on the group-based DCI 220 indicating the first sub-configuration. Conversely, the group-based DCI 220 may indicate, explicitly, that the second sub-configuration is deactivated, such that the UE 115-a may infer, or determine, that the first sub-configuration is activated based on the group-based DCI 220 indicating the second sub-configuration

In some examples, each sub-configuration may be associated with a respective operational state of the UE 115-a from multiple operational states of the UE 115-a. For example, the first sub-configuration may be associated with a high power state and the second sub-configuration may be associated with a low power state. In such cases, the group-based DCI 220 may indicate which sub-configuration is activated, which sub-configuration is deactivated, or both, by indicating which operational state (e.g., or states) is activated, which operational state (e.g., or states) is deactivated, or both. For example, the group-based DCI 220 may indicate that the high power state is activated, the low power state is deactivated, or both, such that the UE 115-a may determine that the first sub-configuration is activated and the second sub-configuration is deactivated.

Additionally, or alternatively, the UE 115-a may refrain from activating a sub-configuration (e.g., and deactivating another sub-configuration) until a threshold duration (e.g., applicability duration, switching duration) after reception of the group-based DCI 220 (e.g., after a last symbol of a physical downlink control channel (PDCCH) carrying the group-based DCI 220). In other words, the UE 115-a may refrain from applying a scheduling restriction indicated via the group-based DCI 220 until the threshold duration after reception of the group-based DCI 220. For example, the UE 115-a may receive, at a first time, the group-based DCI 220 indicating activation of the first sub-configuration and deactivation of the second sub-configuration, and may activate, at a second time, the first sub-configuration and deactivated the second sub-configuration, where a difference between the first time and the second time satisfies the threshold duration. In some cases, the threshold duration (e.g., 1 slot) may be based on a capability of the UE 115-a. For example, the threshold duration may be equal to a duration associated with RF retuning at the UE 115-a, BB clock retuning at the UE 115-a, or both (e.g., which is less than the timeline associated with a BWP switch including RF retuning, BB clock retuning, and reconfiguration). Additionally, or alternatively, the threshold duration may be equal to a duration associated with activating one or more antennas, activating an RF chain, or both.

Additionally, or alternatively, the UE 115-a may transmit a feedback message 225 (e.g., explicit feedback) in response to the group-based DCI 220. For example, the feedback message 225 may indicate acknowledgment, or acceptance of, the scheduling restriction. In such cases, the network entity 105-a (e.g., and the UE 115-a) may refrain from applying a scheduling restriction indicated via the group-based DCI until reception (e.g., or transmission) of the feedback message 225. In other words, the UE 115-a may apply the scheduling restriction based on transmission of the feedback message 225 (e.g., indicating the acknowledgment) and, similarly, the network entity 105-a may apply the scheduling restriction based on reception of the feedback message 225 (e.g., indicating the acknowledgment). In some other examples, the feedback message 225 may indicate rejection of the scheduling restriction (e.g., a negative acknowledgment), such that the network entity 105-a (e.g., and the UE 115-a) may refrain from applying the scheduling restriction based on the feedback message 225 indicating rejection of the scheduling restriction.

Though described in the context of a first sub-configuration and a second sub-configuration, this is not to be intended as a limitation of the present disclosure. In this regard, any quantity of sub-configurations may be considered with regards to the techniques described herein, such that a group-based DCI 220 may indicate activation of any quantity of sub-configurations, deactivation of any quantity of sub-configurations, or both.

FIG. 3 shows examples of configuration diagrams 300 (e.g., a configuration diagram 300-a, a configuration diagram 300-b, and a configuration diagram 300-c) that supports techniques for enabling bandwidth adaption via group-based DCI in accordance with one or more aspects of the present disclosure. In some cases, the configuration diagrams 300 may implement or be implemented by aspects of the wireless communications system 100, the wireless communications system 200, or both. For example, the configuration diagrams 300 may be implemented by one or more UEs 115 and one or more network entities 105, which may be examples of the corresponding devices as described herein.

As described with reference to FIG. 2, in some cases, a UE 115 may receive, from a network entity 105, first control signaling indicative of a configuration associated with a BWP (e.g., a limited BWP within a BW) and second control signaling indicative of multiple sub-configurations associated with the BWP. Thus, the UE 115 may receive a group-based DCI indicating one or more activated sub-configurations (e.g., from the multiple sub-configurations), one or more deactivated sub-configurations (e.g., from the multiple sub-configurations), or both (e.g., which sub-configuration(s) are activated, which sub-configuration(s) are deactivated, or both).

In some cases, as described with reference to the configuration diagram 300-a, the configuration associated with the BWP may indicate a threshold (e.g., maximum) active BWP 305 (e.g., one or more registers at the UE 115 may be time programmed to handle the maximum active BWP 305 or carrier BW) and each sub-configuration may be associated with a subset of the active BWP 305 (e.g., the network entity 105 may guarantee only a subset of the BWP 305 may be scheduled or activated at a given time). That is, the active BWP 305 (e.g., or carrier BW) may include multiple RBs 310 (e.g., or sub-bands), such as an RB 310-a, an RB 310-b, an RB 310-c, an RB 310-d, an RB 310-e, an RB 310-f, an RB 310-g, and an RB 310-h, and the multiple RBs 310 (e.g., or sub-bands) may be grouped (e.g., or divided) into multiple RB sets 315 (e.g., RB groups, sets of RBs 310, sub-band groups). For example, the active BWP 305 may be divided (e.g., by the network entity 105) into an RB set 315-a, an RB set 315-b, and an RB set 315-c. Thus, the group-based DCI may indicate one or more activated sub-configurations by indicating one or more activated RB sets 315, may indicate one or more deactivated sub-configurations by indicating one or more deactivated RB sets 315, or both. In other words, the group-based DCI may indicate which RB sets 315 (e.g., from the multiple RB sets 315) may be scheduled (e.g., are available to be scheduled by the network entity 105), which RB sets 315 (e.g., from the multiple RB sets 315) may be not scheduled (e.g., are guaranteed not to be scheduled by the network entity 105), or both.

In some examples, the network entity 105 may transmit (e.g., via the first control signaling, via the second control signaling, via semi-static RRC signaling, or any combination thereof) an indication of a first table associated with the multiple sub-configurations. For example, the first table may include multiple indexes, where each index (e.g., of the multiple indexes) corresponds to one or more activated RBs sets 315 (e.g., RB sets 315 that may be scheduled), one or more deactivates RB sets (e.g., RB sets 315 that may not be scheduled) or both, such that the group-based DCI may indicate one or more activated sub-configurations, one or more deactivated sub-configurations, or both, by indicating an index from the multiple indexes. For example, a first index may correspond to the RB set 315-a being activated and the RB set 315-b and the RB set 315-c being deactivated, a second index may correspond to the RB set 315-a and the RB set 315-b being activated and the RB set 315-c being deactivated, and a third index may correspond to the RB set 315-a, the RB set 315-b, and the RB set 315-c being activated.

In some cases, the first table may be common for uplink slots, downlink slots, special(S) slots, or any combination thereof. In other words, the UE 115 may not expect that different slots (e.g., different slot types) have different RF BWs (e.g., different active sub-configurations). In some other cases, the first table may not be common for uplink slots, downlink slots, S slots, or any combination thereof. For example, the first table may not be common for periodic channel state information-reference signals (CSI-RS), periodic synchronization reference signals (SRS), or both. In either case, enabling activation and deactivation of RB sets 315 within the active BWP 305 may reduce a switching timeline from being based on RF retuning, BB retuning (e.g., of clock frequency, voltage increase, or both), and reconfiguration of the UE 115 to being based on RF retuning and BB retuning (e.g., when the UE 115 is indicate to switch from narrow band to wide band).

Additionally, or alternatively, as described with reference to the configuration diagram 300-b, the configuration associated with the BWP may indicate a threshold (e.g., maximum) quantity of layers 320 (e.g., one or more registers at the UE 115 may be time programmed to handle the maximum quantity of layers 320 or antennas), and each sub-configuration may be associated with a subset of the threshold quantity of layers 320 (e.g., the network entity 105 may guarantee only a subset of the maximum quantity of layers 320 may be scheduled or activated at a given time). That is, the threshold quantity of layers 320 (e.g., or antennas) may include a layer 320-a, a layer 320-b, a layer 320-c, a layer 320-d, a layer 320-e, a layer 320-f, a layer 320-g, and a layer 320-h, and the threshold quantity of layers 320 (e.g., or antennas) may be grouped (e.g., or divided) into multiple layer sets 325 (e.g., layer groups, antenna groups, sets of layers 320). For example, the threshold quantity of layers 320 may be divided (e.g., by the network entity 105) into a layer set 325-a, a layer set 325-b, and a layer set 325-c. In another example, the threshold quantity of layers may include 8 layers, such that the layers may be divided (e.g., segmented) to 1, 2, 4, and 8. Thus, the group-based DCI may indicate one or more activated sub-configurations by indicating one or more activated layer sets 325, may indicate one or more deactivated sub-configurations by indicating one or more deactivated layer sets 325, or both. In other words, the group-based DCI may indicate which layer sets 325 (e.g., from the multiple layer sets 325) may be scheduled (e.g., are available to be scheduled by the network entity 105), which layer sets 325 (e.g., from the multiple layer sets 325) may be not scheduled (e.g., are guaranteed not to be scheduled by the network entity 105), or both. In some cases, the group-based DCI may include a group common radio network temporary identifier (RNTI) or a portion of the group-based DCI may be scrambled by the group common RNTI (e.g., cyclic redundancy check of the group-based DCI may be scrambled by the group common RNTI).

In some examples, the network entity 105 may transmit (e.g., via the first control signaling, via the second control signaling, via semi-static RRC signaling, or any combination thereof) an indication of a second table associated with the multiple sub-configurations. For example, the second table may include multiple indexes, where each index (e.g., of the multiple indexes) corresponds to one or more activated layer sets 325 (e.g., layer sets 325 that may be scheduled), one or more deactivated layer sets 325 (e.g., layer sets 325 that may not be scheduled) or both, such that the group-based DCI may indicate one or more activated sub-configurations, one or more deactivated sub-configurations, or both, by indicating an index from the multiple indexes. For example, a first index may correspond to the layer set 325-a being activated and the layer set 325-b and the layer set 325-c being deactivated, a second index may correspond to the layer set 325-a and the layer set 325-b being activated and the layer set 325-c being deactivated, and a third index may correspond to the layer set 325-a, the layer set 325-b, and the layer set 325-c being activated.

In some cases, the second table may not be common for uplink slots and downlink slots. In other words, the one or more activated layer sets 325, the one or more deactivated layer sets 325, or both, indicated via the group-based DCI may be different for downlink and uplink. In any case, enabling activation and deactivation of layer sets 325 may reduce a switching timeline from being based on RF retuning, BB retuning (e.g., of clock frequency, voltage increase, or both), and reconfiguration of the UE 115 to being based on a duration associated with activating, or turning on, one or more RF chains.

Additionally, or alternatively, as described with reference to the configuration diagram 300-c, the configuration associated with the BWP may indicate a threshold (e.g., maximum) quantity of MCSs 330 (e.g., one or more registers at the UE 115 may be time programmed to handle the maximum quantity of MCSs 330), and each sub-configuration may be associated with a subset of the threshold quantity of MCSs 330 (e.g., the network entity 105 may guarantee only a subset of the maximum quantity of MCSs 330 may be scheduled or activated at a given time). That is, the threshold quantity of MCSs 330 may include an MCS 330-a, an MCS 330-b, an MCS 330-c, an MCS 330-d, an MCS 330-e, an MCS 330-f, an MCS 330-g, and an MCS 330-h, and the threshold quantity of MCSs 330 may be grouped (e.g., or divided) into multiple MCS sets 335 (e.g., MCS groups, set of MCSs 330). For example, the threshold quantity of MCSs 330 may be divided (e.g., by the network entity 105) into an MCS set 335-a, an MCS set 335-b, and an MCS set 335-c. Thus, the group-based DCI may indicate one or more activated sub-configurations by indicating one or more activated MCS sets 335, may indicate one or more deactivated sub-configurations by indicating one or more deactivated MCS sets 335, or both. In other words, the group-based DCI may indicate which MCS sets 335 (e.g., from the multiple MCS sets 335) may be scheduled (e.g., are available to be scheduled by the network entity 105), which MCS sets 335 (e.g., from the multiple MCS sets 335) may be not scheduled (e.g., are guaranteed not to be scheduled by the network entity 105), or both. In some cases, the group-based DCI may include a group common radio network temporary identifier (RNTI) or a portion of the group-based DCI may be scrambled by the group common RNTI (e.g., cyclic redundancy check of the group-based DCI may be scrambled by the group common RNTI).

In some examples, the network entity 105 may transmit (e.g., via the first control signaling, via the second control signaling, via semi-static RRC signaling, or any combination thereof) an indication of a third table associated with the multiple sub-configurations. For example, the third table may include multiple indexes, where each index (e.g., of the multiple indexes) corresponds to one or more activated MCS sets 335 (e.g., MCS sets 335 that may be scheduled), one or more deactivated MCS sets 335 (e.g., MCS sets 335 that may not be scheduled) or both, such that the group-based DCI may indicate one or more activated sub-configurations, one or more deactivated sub-configurations, or both, by indicating an index from the multiple indexes. For example, a first index may correspond to the MCS sets 335-a being activated and the MCS sets 335-b and the MCS sets 335-c being deactivated, a second index may correspond to the MCS sets 335-a and the MCS sets 335-b being activated and the MCS sets 335-c being deactivated, and a third index may correspond to the MCS sets 335-a, the MCS sets 335-b, and the MCS sets 335-c being activated.

In some cases, the third table may not be common for uplink slots and downlink slots. In other words, the one or more activated MCS sets 335, the one or more deactivated MCS sets 335, or both, indicated via the group-based DCI may be different for downlink and uplink. As described herein, it is understood that the term “MCS 330” and “MCS set 335” may be synonymous with “MCS value 330” or “MCS entry 330” and “MCS value set 335” or “MCS entry set 335,” respectively.

Though described in the context of RBs 310, layers 320, and MCSs 330, this is not intended to be a limitation of the present disclosure. In this regard, any other operational parameters may be considered with regards to the techniques described herein, such that the configuration associated with the BWP may indicate a threshold quantity of values for an operational parameter and each sub-configuration may be associated with a subset of the threshold quantity of values.

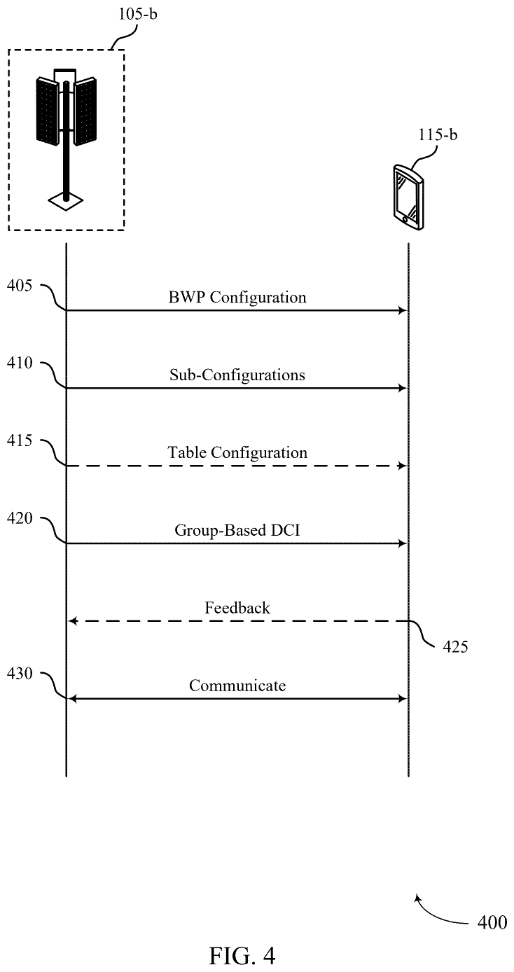

FIG. 4 shows an example of a process flow 400 that supports techniques for enabling bandwidth adaption via group-based DCI in accordance with one or more aspects of the present disclosure. In some cases, the process flow 400 may implement or be implemented by aspects of the wireless communications system 100, the wireless communications system 200, the configuration diagrams 300, or any combination thereof. For example, the process flow 400 may include one or more UEs 115 (e.g., a UE 115-b) and one or more network entities 105 (e.g., a network entity 105-b), which may be examples of the corresponding devices as described herein. In the following description of the process flow 400, the operations between the UE 115-b and the network entity 105-b may be communicated in a different order than the example order shown, or the operations performed by the UE 115-b and the network entity 105-b may be performed in different orders or at different times. Some operations may also be omitted from the process flow 400, and other operations may be added to the process flow 400.

At 405, the UE 115-b may receive, from the network entity 105-b, first control signaling indicative of a configuration of BWP (e.g., a BWP configuration).

Additionally, at 410, the UE 115-b may receive, from the network entity 105-b, second control signaling indicative of multiple sub-configurations associated with the BWP. For example, the multiple sub-configurations may include a first sub-configuration associated with a first sub-portion of the BWP (e.g., a first sub-BWP configuration) and a second sub-configuration associated with a second sub-portion of the BWP (e.g., a second sub-BWP configuration), where the first sub-portion is different than the second sub-portion. In other words, the first sub-portion and the second sub-portion may be at least partially non-overlapping in a frequency domain.

In some cases, the first sub-configuration may be associated with a first operational state and the second sub-configuration may be associated with a second operational state.

In some cases, at 415, the UE 115-b may receive, from the network entity 105-b, an indication of one or more tables comprising associations between the multiple sub-configurations and multiple indexes, including at least a first index and a second index.

At 420, the UE 115-b may receive, from the network entity 105-b, a group-based DCI message indicative of which one of the first sub-configuration or the second sub-configuration is activated (e.g., indicative of which sub-configuration is activated, which sub-configuration is deactivated, or both, indicative of a scheduling restriction). In some examples, the group-based DCI may indicate which one of the first sub-configuration or the second sub-configuration is activated by indicating which one of the first sub-configuration or the second sub-configuration is activated (e.g., explicit indication), based at least in part on the group-based downlink control information message being indicative of which one of the first sub-configuration or the second sub-configuration is deactivated (e.g., implicit indication), or both.

In some cases, the group-based DCI message may indicate which one of the first sub-configuration or the second sub-configuration is activated by indicating the first operational state or the second operational state. Additionally, or alternatively, the group-based DCI message may indicate which one of the first sub-configuration or the second sub-configuration is activated by indicating a first index associated with the first sub-configuration, a second index associated with the second sub-configuration, or both.

In some examples, the group-based DCI message may indicate which one of the first sub-configuration or the second sub-configuration is activated for uplink, which one of the first sub-configuration or the second sub-configuration is activated for downlink, or both. Alternatively, the first sub-configuration and the second sub-configuration may be common to uplink and downlink.

In some cases, the BWP may be associated with multiple RBs (e.g., sub-bands), where the multiple RBs include a first set of RBs (e.g., a first set of sub-bands) associated with the first sub-portion and a second set of RBs (e.g., a second set of sub-bands) associated with the second sub-portion. In such cases, the group based DCI message may indicate which one of the first sub-configuration or the second sub-configuration is activated by indicating which of the first set of RBs or the second set of RBs is activated, which of the first set of RBs or the second set of RBs is deactivated, or both.

In some cases, the BWP may be associated with multiple layers (e.g., antennas), where the multiple layers include a first set of layers (e.g., a first set of antennas) associated with the first sub-portion and a second set of layers (e.g., a second set of antennas) associated with the second sub-portion. In such cases, the group based DCI message may indicate which one of the first sub-configuration or the second sub-configuration is activated by indicating which of the first set of layers or the second set of layers is activated, which of the first set of layers or the second set of layers is deactivated, or both.

In some cases, the BWP may be associated with multiple MCSs (e.g., MCS values), where the multiple MCSs include a first set of MCSs (e.g., a first set of MCS values) associated with the first sub-portion and a second set of MCSs (e.g., a second set of MCS values) associated with the second sub-portion. In such cases, the group based DCI message may indicate which one of the first sub-configuration or the second sub-configuration is activated by indicating which of the first set of MCSs or the second set of MCSs is activated, which of the first set of MCSs or the second set of MCSs is deactivated, or both.

In some cases, at 425, the UE 115-b may transmit, to the network entity 105-b, a feedback message in response to the group-based downlink control information message. The feedback message may indicate successful decoding of the group-based DCI message (e.g., ACK) or unsuccessful decoding of the group-based DCI message (e.g., NACK). Additionally, or alternatively, the feedback message may indicate acceptance of the scheduling restriction or rejection of the scheduling restriction.

At 430, the UE 115-b may communicate (e.g., one or more messages) with the network entity 105-b (e.g., and visa-versa) based on reception of the group-based DCI message and in accordance with activation of one of the first sub-configuration or the second sub-configuration (e.g., and based on transmission/reception of the feedback message).

In some examples, the UE 115-b (e.g., or the network entity 105-b) may communicate the one or more messages at a first time, where a duration between a last symbol of a downlink control channel (e.g., PDCCH) carrying the group-based DCI message and the first time satisfies a threshold duration (e.g., applicability time). In other words, the UE 115-b may not apply the scheduling restriction indicated via the group-based DCI message until the threshold duration after the last symbol of a downlink control channel carrying the group-based DCI message.

As described herein, the term “a set” may refer to a set of one or more (e.g., a set of one or a set of multiple).

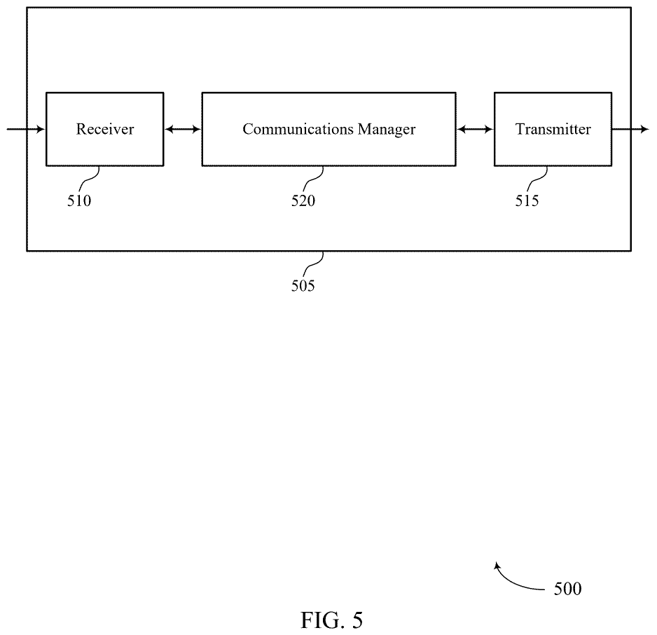

FIG. 5 shows a block diagram 500 of a device 505 that supports techniques for enabling bandwidth adaption via group-based DCI in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for enabling bandwidth adaption via group-based DCI). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for enabling bandwidth adaption via group-based DCI). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for enabling bandwidth adaption via group-based DCI as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), a microcontroller, an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, a GPU, an NPU, a microcontroller, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving first control signaling indicative of a configuration of a BWP. The communications manager 520 is capable of, configured to, or operable to support a means for receiving second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion. The communications manager 520 is capable of, configured to, or operable to support a means for receiving a group-based DCI message indicative of which one of the first sub-configuration or the second sub-configuration is activated. The communications manager 520 is capable of, configured to, or operable to support a means for communicating, based on the group-based DCI message, one or more messages in accordance with activation of one of the first sub-configuration or the second sub-configuration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for enabling bandwidth adaption via group-based DCI, which may result in reduced processing, reduced power consumption, and more efficient utilization of communication resources, among other advantages.

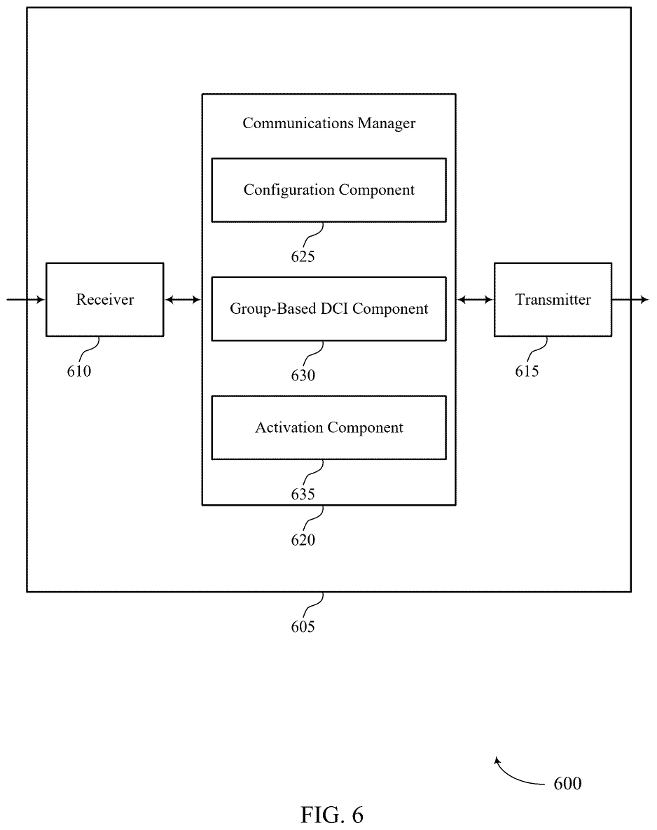

FIG. 6 shows a block diagram 600 of a device 605 that supports techniques for enabling bandwidth adaption via group-based DCI in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for enabling bandwidth adaption via group-based DCI). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for enabling bandwidth adaption via group-based DCI). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for enabling bandwidth adaption via group-based DCI as described herein. For example, the communications manager 620 may include a configuration component 625, a group-based DCI component 630, an activation component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration component 625 is capable of, configured to, or operable to support a means for receiving first control signaling indicative of a configuration of a BWP. The configuration component 625 is capable of, configured to, or operable to support a means for receiving second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion. The group-based DCI component 630 is capable of, configured to, or operable to support a means for receiving a group-based DCI message indicative of which one of the first sub-configuration or the second sub-configuration is activated. The activation component 635 is capable of, configured to, or operable to support a means for communicating, based on the group-based DCI message, one or more messages in accordance with activation of one of the first sub-configuration or the second sub-configuration.

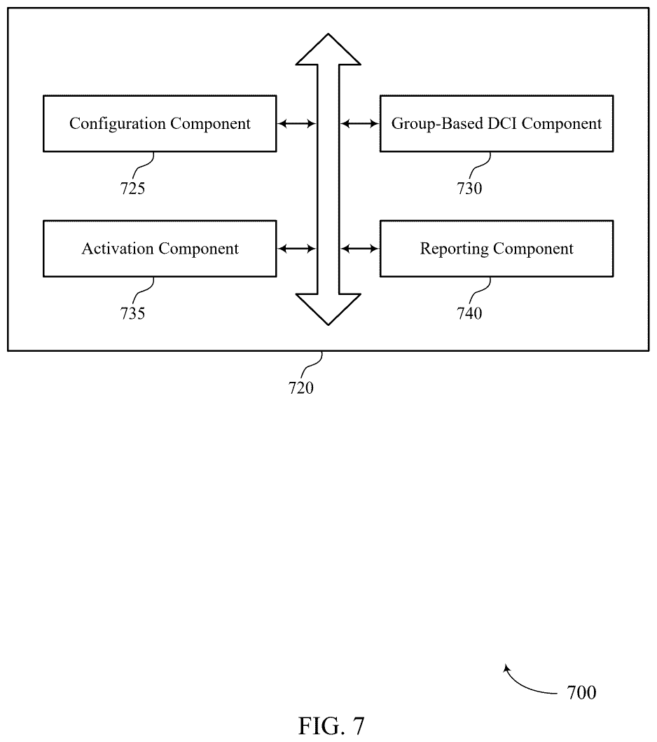

FIG. 7 shows a block diagram 700 of a communications manager 720 that supports techniques for enabling bandwidth adaption via group-based DCI in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for enabling bandwidth adaption via group-based DCI as described herein. For example, the communications manager 720 may include a configuration component 725, a group-based DCI component 730, an activation component 735, a reporting component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration component 725 is capable of, configured to, or operable to support a means for receiving first control signaling indicative of a configuration of a BWP. In some examples, the configuration component 725 is capable of, configured to, or operable to support a means for receiving second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion. The group-based DCI component 730 is capable of, configured to, or operable to support a means for receiving a group-based DCI message indicative of which one of the first sub-configuration or the second sub-configuration is activated. The activation component 735 is capable of, configured to, or operable to support a means for communicating, based on the group-based DCI message, one or more messages in accordance with activation of one of the first sub-configuration or the second sub-configuration.

In some examples, the first sub-configuration is associated with a first operational state. In some examples, the second sub-configuration is associated with a second operational state. In some examples, the group-based DCI message is indicative of which one of the first sub-configuration or the second sub-configuration is activated based on the group-based DCI message being indicative of the first operational state or the second operational state.

In some examples, the group-based DCI message is indicative of which one of the first sub-configuration or the second sub-configuration is activated based on the group-based DCI message being indicative of a first index associated with the first sub-configuration, a second index associated with the second sub-configuration, or both.

In some examples, the configuration component 725 is capable of, configured to, or operable to support a means for receiving an indication of table including associations between the set of multiple sub-configurations and a set of multiple indexes, including at least the first index and the second index.

In some examples, the one or more messages are communicated at a first time. In some examples, a duration between a last symbol of a downlink control channel carrying the group-based DCI message and the first time satisfies a threshold duration.

In some examples, the threshold duration is based on a retuning capability of the UE.

In some examples, the reporting component 740 is capable of, configured to, or operable to support a means for transmitting a feedback message in response to the group-based DCI message, where communicating the one or more messages is based on transmission of the feedback message.

In some examples, the group-based DCI message is indicative of which one of the first sub-configuration or the second sub-configuration is activated for uplink, which one of the first sub-configuration or the second sub-configuration is activated for downlink, or both.

In some examples, each of the first sub-configuration and the second sub-configuration are common to uplink and downlink.

In some examples, the group-based DCI message is indicative of which one of the first sub-configuration or the second sub-configuration is activated based on the group-based DCI message being indicative of which one of the first sub-configuration or the second sub-configuration is activated, based on the group-based DCI message being indicative of which one of the first sub-configuration or the second sub-configuration is deactivated, or both.

In some examples, the BWP is associated with a set of multiple RBs. In some examples, the set of multiple RBs includes a first set of RBs associated with the first sub-portion and a second set of RBs associated with the second sub-portion.

In some examples, the group-based DCI message is indicative of which one of the first sub-configuration or the second sub-configuration is activated based on the group-based DCI message being indicative of which of the first set of RBs or the second set of RBs is activated, which of the first set of RBs or the second set of RBs is deactivated, or both.

In some examples, the BWP is associated with a set of multiple layers. In some examples, the set of multiple layers includes a first set of layers associated with the first sub-portion and a second set of layers associated with the second sub-portion.

In some examples, the group-based DCI message is indicative of which one of the first sub-configuration or the second sub-configuration is activated based on the group-based DCI message being indicative of which of the first set of layers or the second set of layers is activated, which of the first set of layers or the second set of layers is deactivated, or both.

In some examples, the BWP is associated with a set of multiple MCSs. In some examples, the set of multiple MCSs includes a first set of MCSs associated with the first sub-portion and a second set of MCSs associated with the second sub-portion.

In some examples, the group-based DCI message is indicative of which one of the first sub-configuration or the second sub-configuration is activated based on the group-based DCI message being indicative of which of the first set of MCSs or the second set of MCSs is activated, which of the first set of MCSs or the second set of MCSs is deactivated, or both.

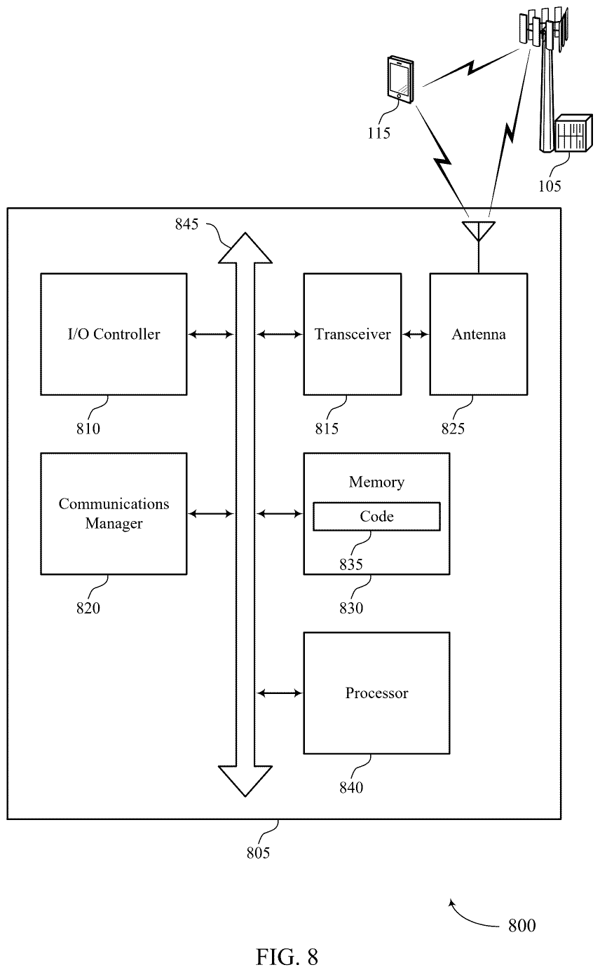

FIG. 8 shows a diagram of a system 800 including a device 805 that supports techniques for enabling bandwidth adaption via group-based DCI in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for enabling bandwidth adaption via group-based DCI). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving first control signaling indicative of a configuration of a BWP. The communications manager 820 is capable of, configured to, or operable to support a means for receiving second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion. The communications manager 820 is capable of, configured to, or operable to support a means for receiving a group-based DCI message indicative of which one of the first sub-configuration or the second sub-configuration is activated. The communications manager 820 is capable of, configured to, or operable to support a means for communicating, based on the group-based DCI message, one or more messages in accordance with activation of one of the first sub-configuration or the second sub-configuration.

By including or configuring the communications manager 820 in accordance with examples as described herein, the device 805 may support techniques for enabling bandwidth adaption via group-based DCI, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for enabling bandwidth adaption via group-based DCI as described herein, or the at least one processor 840 and the at least one memory 830 may be otherwise configured to, individually or collectively, perform or support such operations.

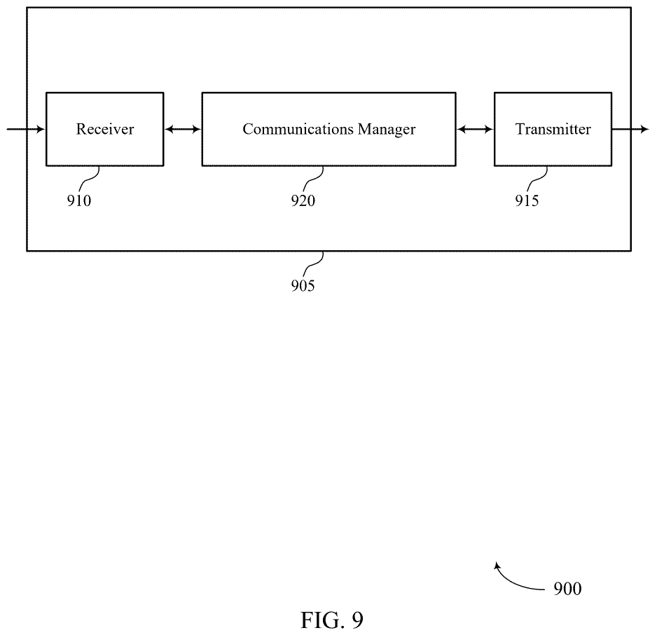

FIG. 9 shows a block diagram 900 of a device 905 that supports techniques for enabling bandwidth adaption via group-based DCI in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for enabling bandwidth adaption via group-based DCI as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, a GPU, an NPU, a microcontroller, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, a GPU, an NPU, a microcontroller, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting first control signaling indicative of a configuration of a BWP. The communications manager 920 is capable of, configured to, or operable to support a means for transmitting second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion. The communications manager 920 is capable of, configured to, or operable to support a means for transmitting a group-based DCI message indicative of which one of the first sub-configuration or the second sub-configuration is activated. The communications manager 920 is capable of, configured to, or operable to support a means for communicating, based on the group-based DCI message, one or more messages in accordance with activation of one of the first sub-configuration or the second sub-configuration.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for enabling bandwidth adaption via group-based DCI, which may result in reduced processing, reduced power consumption, and more efficient utilization of communication resources.

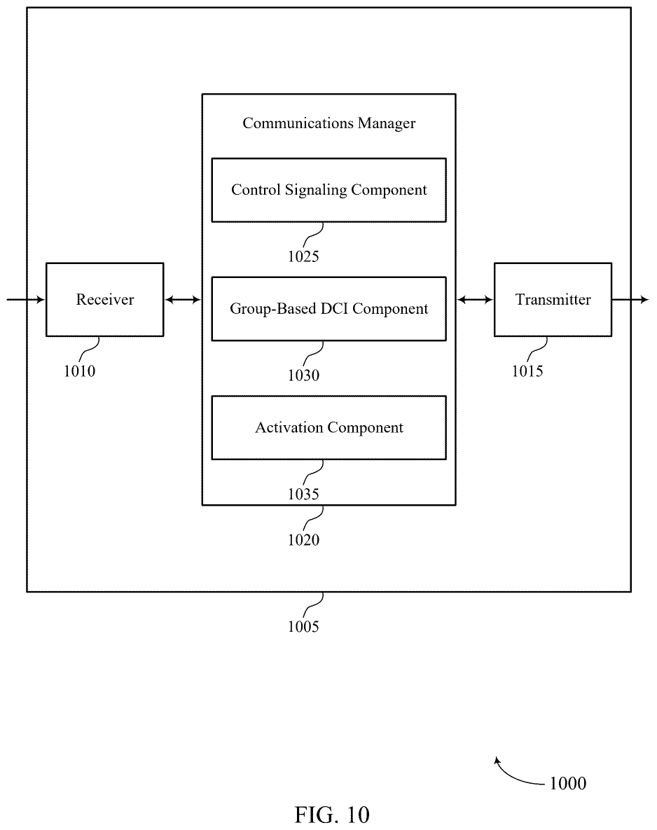

FIG. 10 shows a block diagram 1000 of a device 1005 that supports techniques for enabling bandwidth adaption via group-based DCI in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for enabling bandwidth adaption via group-based DCI as described herein. For example, the communications manager 1020 may include a control signaling component 1025, a group-based DCI component 1030, an activation component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The control signaling component 1025 is capable of, configured to, or operable to support a means for transmitting first control signaling indicative of a configuration of a BWP. The control signaling component 1025 is capable of, configured to, or operable to support a means for transmitting second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion. The group-based DCI component 1030 is capable of, configured to, or operable to support a means for transmitting a group-based DCI message indicative of which one of the first sub-configuration or the second sub-configuration is activated. The activation component 1035 is capable of, configured to, or operable to support a means for communicating, based on the group-based DCI message, one or more messages in accordance with activation of one of the first sub-configuration or the second sub-configuration.

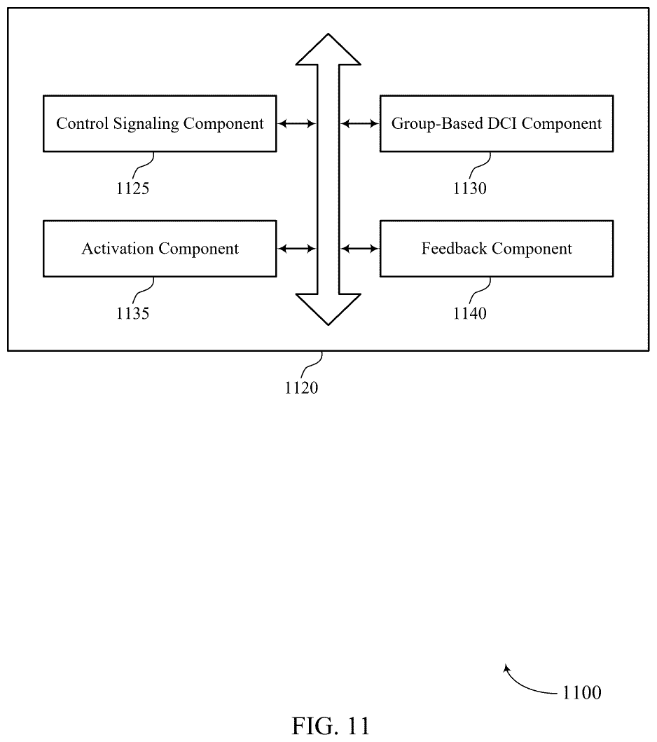

FIG. 11 shows a block diagram 1100 of a communications manager 1120 that supports techniques for enabling bandwidth adaption via group-based DCI in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for enabling bandwidth adaption via group-based DCI as described herein. For example, the communications manager 1120 may include a control signaling component 1125, a group-based DCI component 1130, an activation component 1135, a feedback component 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The control signaling component 1125 is capable of, configured to, or operable to support a means for transmitting first control signaling indicative of a configuration of a BWP. In some examples, the control signaling component 1125 is capable of, configured to, or operable to support a means for transmitting second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion. The group-based DCI component 1130 is capable of, configured to, or operable to support a means for transmitting a group-based DCI message indicative of which one of the first sub-configuration or the second sub-configuration is activated. The activation component 1135 is capable of, configured to, or operable to support a means for communicating, based on the group-based DCI message, one or more messages in accordance with activation of one of the first sub-configuration or the second sub-configuration.

In some examples, the first sub-configuration is associated with a first operational state. In some examples, the second sub-configuration is associated with a second operational state. In some examples, the group-based DCI message is indicative of which one of the first sub-configuration or the second sub-configuration is activated based on the group-based DCI message being indicative of the first operational state or the second operational state.

In some examples, the group-based DCI message is indicative of which one of the first sub-configuration or the second sub-configuration is activated based on the group-based DCI message being indicative of a first index associated with the first sub-configuration, a second index associated with the second sub-configuration, or both.

In some examples, the control signaling component 1125 is capable of, configured to, or operable to support a means for transmitting an indication of table including associations between the set of multiple sub-configurations and a set of multiple indexes, including at least the first index and the second index.

In some examples, the one or more messages are communicated at a first time. In some examples, a duration between a last symbol of a downlink control channel carrying the group-based DCI message and the first time satisfies a threshold duration.

In some examples, the threshold duration is based on a retuning capability of a UE.

In some examples, the feedback component 1140 is capable of, configured to, or operable to support a means for receiving a feedback message in response to the group-based DCI message, where communication of the one or more messages is based on transmission of the feedback message.

In some examples, the group-based DCI message is indicative of which one of the first sub-configuration or the second sub-configuration is activated for uplink, which one of the first sub-configuration or the second sub-configuration is activated for downlink, or both.

In some examples, each of the first sub-configuration and the second sub-configuration are common to uplink and downlink.

In some examples, the group-based DCI message is indicative of which one of the first sub-configuration or the second sub-configuration is activated based on the group-based DCI message being indicative of which one of the first sub-configuration or the second sub-configuration is activated, based on the group-based DCI message being indicative of which one of the first sub-configuration or the second sub-configuration is deactivated, or both.

In some examples, the BWP is associated with a set of multiple RBs. In some examples, the set of multiple RBs includes a first set of RBs associated with the first sub-portion and a second set of RBs associated with the second sub-portion.

In some examples, the group-based DCI message is indicative of which one of the first sub-configuration or the second sub-configuration is activated based on the group-based DCI message being indicative of which of the first set of RBs or the second set of RBs is activated, which of the first set of RBs or the second set of RBs is deactivated, or both.

In some examples, the BWP is associated with a set of multiple layers. In some examples, the set of multiple layers includes a first set of layers associated with the first sub-portion and a second set of layers associated with the second sub-portion.

In some examples, the group-based DCI message is indicative of which one of the first sub-configuration or the second sub-configuration is activated based on the group-based DCI message being indicative of which of the first set of layers or the second set of layers is activated, which of the first set of layers or the second set of layers is deactivated, or both.

In some examples, the BWP is associated with a set of multiple MCSs. In some examples, the set of multiple MCSs includes a first set of MCSs associated with the first sub-portion and a second set of MCSs associated with the second sub-portion.

In some examples, the group-based DCI message is indicative of which one of the first sub-configuration or the second sub-configuration is activated based on the group-based DCI message being indicative of which of the first set of MCSs or the second set of MCSs is activated, which of the first set of MCSs or the second set of MCSs is deactivated, or both.

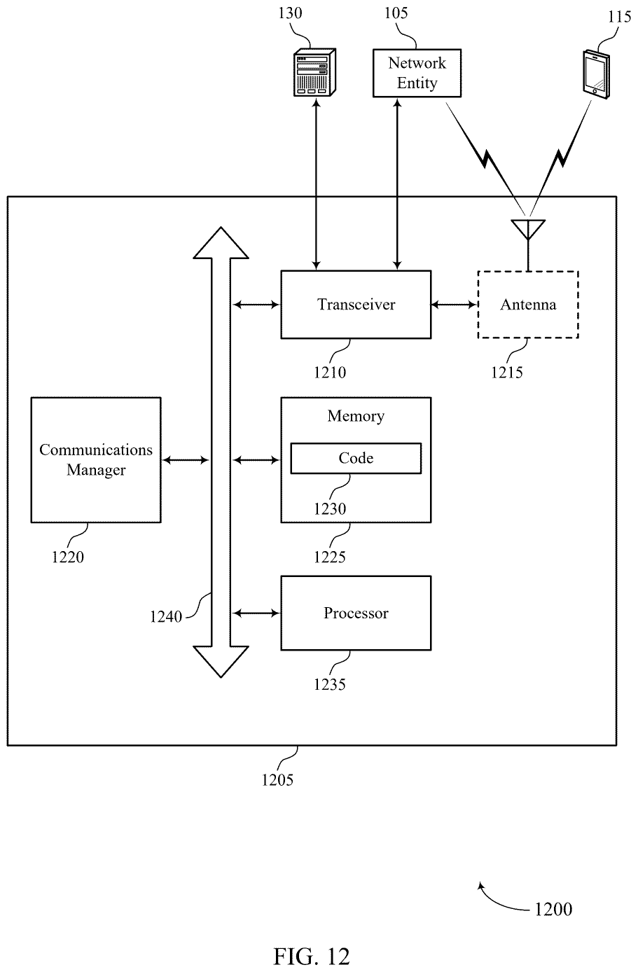

FIG. 12 shows a diagram of a system 1200 including a device 1205 that supports techniques for enabling bandwidth adaption via group-based DCI in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for enabling bandwidth adaption via group-based DCI). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting first control signaling indicative of a configuration of a BWP. The communications manager 1220 is capable of, configured to, or operable to support a means for transmitting second control signaling indicative of a set of multiple sub-configurations associated with the BWP, the set of multiple sub-configurations including a first sub-configuration associated with a first sub-portion of the BWP and a second sub-configuration associated with a second sub-portion of the BWP, where the first sub-portion is different than the second sub-portion. The communications manager 1220 is capable of, configured to, or operable to support a means for transmitting a group-based DCI message indicative of which one of the first sub-configuration or the second sub-configuration is activated. The communications manager 1220 is capable of, configured to, or operable to support a means for communicating, based on the group-based DCI message, one or more messages in accordance with activation of one of the first sub-configuration or the second sub-configuration.

By including or configuring the communications manager 1220 in accordance with examples as described herein, the device 1205 may support techniques for enabling bandwidth adaption via group-based DCI, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for enabling bandwidth adaption via group-based DCI as described herein, or the at least one processor 1235 and the at least one memory 1225 may be otherwise configured to, individually or collectively, perform or support such operations.

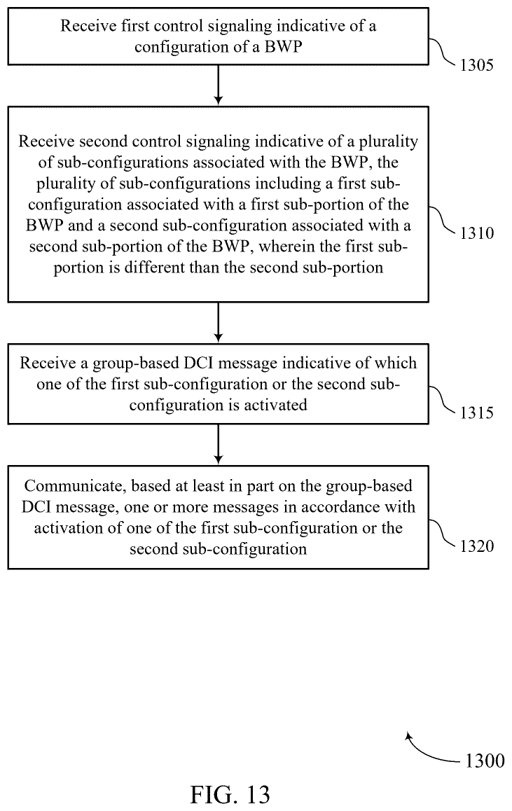

FIG. 13 shows a flowchart illustrating a method 1300 that supports techniques for enabling bandwidth adaption via group-based DCI in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving first control signaling indicative of a configuration of a BWP. The operations of 1305 may be performed in accordance with examples as disclosed herein. In some examples, aspects of the operations of 1305 may be performed by a configuration component 725 as described with reference to FIG. 7.

At 1310, the method may include receiving second control signaling indicative of a plurality of sub-configurations associated with the BWP, the plurality of sub-configurations comprising a first sub-configuration associated with a first sub-portion of the BWP and a second sub-configuration associated with a second sub-portion of the BWP, wherein the first sub-portion is different than the second sub-portion. The operations of 1310 may be performed in accordance with examples as disclosed herein. In some examples, aspects of the operations of 1310 may be performed by a configuration component 725 as described with reference to FIG. 7.

At 1315, the method may include receiving a group-based DCI message indicative of which one of the first sub-configuration or the second sub-configuration is activated. The operations of 1315 may be performed in accordance with examples as disclosed herein. In some examples, aspects of the operations of 1315 may be performed by a group-based DCI component 730 as described with reference to FIG. 7.

At 1320, the method may include communicating, based at least in part on the group-based DCI message, one or more messages in accordance with activation of one of the first sub-configuration or the second sub-configuration. The operations of 1320 may be performed in accordance with examples as disclosed herein. In some examples, aspects of the operations of 1320 may be performed by an activation component 735 as described with reference to FIG. 7.

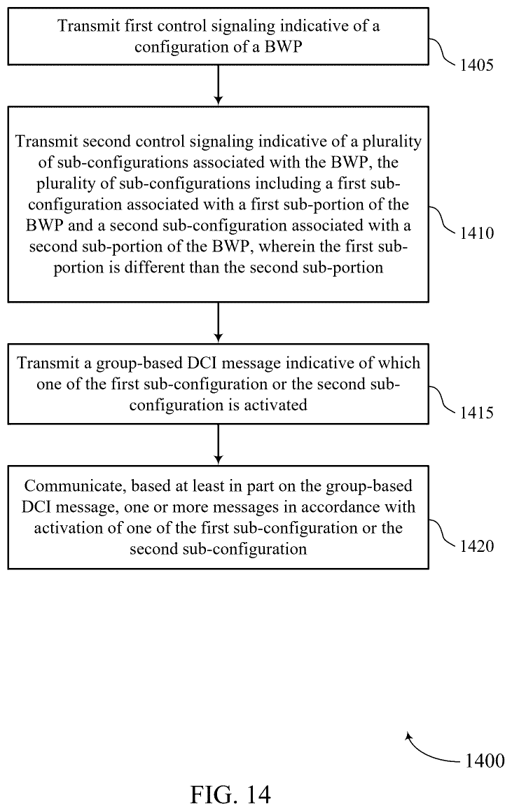

FIG. 14 shows a flowchart illustrating a method 1400 that supports techniques for enabling bandwidth adaption via group-based DCI in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting first control signaling indicative of a configuration of a BWP. The operations of 1405 may be performed in accordance with examples as disclosed herein. In some examples, aspects of the operations of 1405 may be performed by a control signaling component 1125 as described with reference to FIG. 11.

At 1410, the method may include transmitting second control signaling indicative of a plurality of sub-configurations associated with the BWP, the plurality of sub-configurations comprising a first sub-configuration associated with a first sub-portion of the BWP and a second sub-configuration associated with a second sub-portion of the BWP, wherein the first sub-portion is different than the second sub-portion. The operations of 1410 may be performed in accordance with examples as disclosed herein. In some examples, aspects of the operations of 1410 may be performed by a control signaling component 1125 as described with reference to FIG. 11.

At 1415, the method may include transmitting a group-based DCI message indicative of which one of the first sub-configuration or the second sub-configuration is activated. The operations of 1415 may be performed in accordance with examples as disclosed herein. In some examples, aspects of the operations of 1415 may be performed by a group-based DCI component 1130 as described with reference to FIG. 11.

At 1420, the method may include communicating, based at least in part on the group-based DCI message, one or more messages in accordance with activation of one of the first sub-configuration or the second sub-configuration. The operations of 1420 may be performed in accordance with examples as disclosed herein. In some examples, aspects of the operations of 1420 may be performed by an activation component 1135 as described with reference to FIG. 11.

The following provides an overview of aspects of the present disclosure:
Aspect 1: A method for wireless communications at a UE, comprising: receiving first control signaling indicative of a configuration of a BWP; receiving second control signaling indicative of a plurality of sub-configurations associated with the BWP, the plurality of sub-configurations including a first sub-configuration associated with a first sub-portion of the BWP and a second sub-configuration associated with a second sub-portion of the BWP, wherein the first sub-portion is different than the second sub-portion; receiving a group-based DCI message indicative of which one of the first sub-configuration or the second sub-configuration is activated; and communicating, based at least in part on the group-based DCI message, one or more messages in accordance with activation of one of the first sub-configuration or the second sub-configuration.
Aspect 2: The method of aspect 1, wherein the first sub-configuration is associated with a first operational state, the second sub-configuration is associated with a second operational state, and the group-based DCI message is indicative of which one of the first sub-configuration or the second sub-configuration is activated based at least in part on the group-based DCI message being indicative of the first operational state or the second operational state.
Aspect 3: The method of any of aspects 1 through 2, wherein the group-based DCI message is indicative of which one of the first sub-configuration or the second sub-configuration is activated based at least in part on the group-based DCI message being indicative of a first index associated with the first sub-configuration, a second index associated with the second sub-configuration, or both.

Aspect 4: The method of aspect 3, further comprising: receiving an indication of table comprising associations between the plurality of sub-configurations and a plurality of indexes, including at least the first index and the second index.

Aspect 5: The method of any of aspects 1 through 4, wherein the one or more messages are communicated at a first time, and a duration between a last symbol of a downlink control channel carrying the group-based DCI message and the first time satisfies a threshold duration.

Aspect 6: The method of aspect 5, wherein the threshold duration is based at least in part on a retuning capability of the UE.

Aspect 7: The method of any of aspects 1 through 6, further comprising:
transmitting a feedback message in response to the group-based DCI message, wherein communicating the one or more messages is based at least in part on transmission of the feedback message.
Aspect 8: The method of any of aspects 1 through 7, wherein the group-based DCI message is indicative of which one of the first sub-configuration or the second sub-configuration is activated for uplink, which one of the first sub-configuration or the second sub-configuration is activated for downlink, or both.

Aspect 9: The method of any of aspects 1 through 8, wherein each of the first sub-configuration and the second sub-configuration are common to uplink and downlink.

Aspect 10: The method of any of aspects 1 through 9, wherein the group-based DCI message is indicative of which one of the first sub-configuration or the second sub-configuration is activated based at least in part on the group-based DCI message being indicative of which one of the first sub-configuration or the second sub-configuration is activated, based at least in part on the group-based DCI message being indicative of which one of the first sub-configuration or the second sub-configuration is deactivated, or both.

Aspect 11: The method of any of aspects 1 through 10, wherein the BWP is associated with a plurality of RBs, and the plurality of RBs comprises a first set of RBs associated with the first sub-portion and a second set of RBs associated with the second sub-portion.

Aspect 12: The method of aspect 11, wherein the group-based DCI message is indicative of which one of the first sub-configuration or the second sub-configuration is activated based at least in part on the group-based DCI message being indicative of which of the first set of RBs or the second set of RBs is activated, which of the first set of RBs or the second set of RBs is deactivated, or both.

Aspect 13: The method of any of aspects 1 through 12, wherein the BWP is associated with a plurality of layers, and the plurality of layers comprises a first set of layers associated with the first sub-portion and a second set of layers associated with the second sub-portion.

Aspect 14: The method of aspect 13, wherein the group-based DCI message is indicative of which one of the first sub-configuration or the second sub-configuration is activated based at least in part on the group-based DCI message being indicative of which of the first set of layers or the second set of layers is activated, which of the first set of layers or the second set of layers is deactivated, or both.

Aspect 15: The method of any of aspects 1 through 14, wherein the BWP is associated with a plurality of MCSs, and the plurality of MCSs comprises a first set of MCSs associated with the first sub-portion and a second set of MCSs associated with the second sub-portion.

Aspect 16: The method of aspect 15, wherein the group-based DCI message is indicative of which one of the first sub-configuration or the second sub-configuration is activated based at least in part on the group-based DCI message being indicative of which of the first set of MCSs or the second set of MCSs is activated, which of the first set of MCSs or the second set of MCSs is deactivated, or both.

Aspect 17: A method for wireless communications at a network entity, comprising: transmitting first control signaling indicative of a configuration of a BWP; transmitting second control signaling indicative of a plurality of sub-configurations associated with the BWP, the plurality of sub-configurations including a first sub-configuration associated with a first sub-portion of the BWP and a second sub-configuration associated with a second sub-portion of the BWP, wherein the first sub-portion is different than the second sub-portion; transmitting a group-based DCI message indicative of which one of the first sub-configuration or the second sub-configuration is activated; and communicating, based at least in part on the group-based DCI message, one or more messages in accordance with activation of one of the first sub-configuration or the second sub-configuration.

Aspect 18: The method of aspect 17, wherein the first sub-configuration is associated with a first operational state, the second sub-configuration is associated with a second operational state, and the group-based DCI message is indicative of which one of the first sub-configuration or the second sub-configuration is activated based at least in part on the group-based DCI message being indicative of the first operational state or the second operational state.

Aspect 19: The method of any of aspects 17 through 18, wherein the group-based DCI message is indicative of which one of the first sub-configuration or the second sub-configuration is activated based at least in part on the group-based DCI message being indicative of a first index associated with the first sub-configuration, a second index associated with the second sub-configuration, or both.

Aspect 20: The method of aspect 19, further comprising: transmitting an indication of table comprising associations between the plurality of sub-configurations and a plurality of indexes, including at least the first index and the second index.

Aspect 21: The method of any of aspects 17 through 20, wherein the one or more messages are communicated at a first time, and a duration between a last symbol of a downlink control channel carrying the group-based DCI message and the first time satisfies a threshold duration.

Aspect 22: The method of aspect 21, wherein the threshold duration is based at least in part on a retuning capability of a UE.

Aspect 23: The method of any of aspects 17 through 22, further comprising:
receiving a feedback message in response to the group-based DCI message, wherein communication of the one or more messages is based at least in part on transmission of the feedback message.
Aspect 24: The method of any of aspects 17 through 23, wherein the group-based DCI message is indicative of which one of the first sub-configuration or the second sub-configuration is activated for uplink, which one of the first sub-configuration or the second sub-configuration is activated for downlink, or both.

Aspect 25: The method of any of aspects 17 through 24, wherein each of the first sub-configuration and the second sub-configuration are common to uplink and downlink.

Aspect 26: The method of any of aspects 17 through 25, wherein the group-based DCI message is indicative of which one of the first sub-configuration or the second sub-configuration is activated based at least in part on the group-based DCI message being indicative of which one of the first sub-configuration or the second sub-configuration is activated, based at least in part on the group-based DCI message being indicative of which one of the first sub-configuration or the second sub-configuration is deactivated, or both.

Aspect 27: The method of any of aspects 17 through 26, wherein the BWP is associated with a plurality of RBs, and the plurality of RBs comprises a first set of RBs associated with the first sub-portion and a second set of RBs associated with the second sub-portion.

Aspect 28: The method of aspect 27, wherein the group-based DCI message is indicative of which one of the first sub-configuration or the second sub-configuration is activated based at least in part on the group-based DCI message being indicative of which of the first set of RBs or the second set of RBs is activated, which of the first set of RBs or the second set of RBs is deactivated, or both.

Aspect 29: The method of any of aspects 17 through 28, wherein the BWP is associated with a plurality of layers, and the plurality of layers comprises a first set of layers associated with the first sub-portion and a second set of layers associated with the second sub-portion.

Aspect 30: The method of aspect 29, wherein the group-based DCI message is indicative of which one of the first sub-configuration or the second sub-configuration is activated based at least in part on the group-based DCI message being indicative of which of the first set of layers or the second set of layers is activated, which of the first set of layers or the second set of layers is deactivated, or both.

Aspect 31: The method of any of aspects 17 through 30, wherein the BWP is associated with a plurality of MCSs, and the plurality of MCSs comprises a first set of MCSs associated with the first sub-portion and a second set of MCSs associated with the second sub-portion.

Aspect 32: The method of aspect 31, wherein the group-based DCI message is indicative of which one of the first sub-configuration or the second sub-configuration is activated based at least in part on the group-based DCI message being indicative of which of the first set of MCSs or the second set of MCSs is activated, which of the first set of MCSs or the second set of MCSs is deactivated, or both.

Aspect 33: A UE for wireless communications, comprising one or more memories storing processor-executable code, and one or more processors coupled with the one or more memories and individually or collectively operable to execute the code to cause the UE to perform a method of any of aspects 1 through 16.

Aspect 34: A UE for wireless communications, comprising at least one means for performing a method of any of aspects 1 through 16.

Aspect 35: A non-transitory computer-readable medium storing code for wireless communications, the code comprising instructions executable by one or more processors to perform a method of any of aspects 1 through 16.

Aspect 36: A network entity for wireless communications, comprising one or more memories storing processor-executable code, and one or more processors coupled with the one or more memories and individually or collectively operable to execute the code to cause the network entity to perform a method of any of aspects 17 through 32.

Aspect 37: A network entity for wireless communications, comprising at least one means for performing a method of any of aspects 17 through 32.

Aspect 38: A non-transitory computer-readable medium storing code for wireless communications, the code comprising instructions executable by one or more processors to perform a method of any of aspects 17 through 32.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, a microcontroller, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling indicative of a configuration of a bandwidth part;
receive second control signaling indicative of a plurality of sub-configurations associated with the bandwidth part, the plurality of sub-configurations including a first sub-configuration associated with a first sub-portion of the bandwidth part and a second sub-configuration associated with a second sub-portion of the bandwidth part, wherein the first sub-portion is different than the second sub-portion;
receive a group-based downlink control information message indicative of which one of the first sub-configuration or the second sub-configuration is activated; and
communicate, based at least in part on the group-based downlink control information message, one or more messages in accordance with activation of one of the first sub-configuration or the second sub-configuration.

2. The UE of claim 1, wherein the first sub-configuration is associated with a first operational state, wherein the second sub-configuration is associated with a second operational state, and wherein the group-based downlink control information message is indicative of which one of the first sub-configuration or the second sub-configuration is activated based at least in part on the group-based downlink control information message being indicative of the first operational state or the second operational state.

3. The UE of claim 1, wherein the group-based downlink control information message is indicative of which one of the first sub-configuration or the second sub-configuration is activated based at least in part on the group-based downlink control information message being indicative of a first index associated with the first sub-configuration, a second index associated with the second sub-configuration, or both.

4. The UE of claim 3, wherein the one or more processors are individually or collectively further operable to execute the code to cause the UE to:
receive an indication of table comprising associations between the plurality of sub-configurations and a plurality of indexes, including at least the first index and the second index.

5. The UE of claim 1, wherein the one or more messages are communicated at a first time, and wherein a duration between a last symbol of a downlink control channel carrying the group-based downlink control information message and the first time satisfies a threshold duration.

6. The UE of claim 1, wherein the one or more processors are individually or collectively further operable to execute the code to cause the UE to:
transmit a feedback message in response to the group-based downlink control information message, wherein communicating the one or more messages is based at least in part on transmission of the feedback message.

7. The UE of claim 1, wherein the group-based downlink control information message is indicative of which one of the first sub-configuration or the second sub-configuration is activated for uplink, which one of the first sub-configuration or the second sub-configuration is activated for downlink, or both.

8. The UE of claim 1, wherein the group-based downlink control information message is indicative of which one of the first sub-configuration or the second sub-configuration is activated based at least in part on the group-based downlink control information message being indicative of which one of the first sub-configuration or the second sub-configuration is activated, based at least in part on the group-based downlink control information message being indicative of which one of the first sub-configuration or the second sub-configuration is deactivated, or both.

9. The UE of claim 1, wherein the bandwidth part is associated with a plurality of resource blocks, and wherein the plurality of resource blocks comprises a first set of resource blocks associated with the first sub-portion and a second set of resource blocks associated with the second sub-portion.

10. The UE of claim 9, wherein the group-based downlink control information message is indicative of which one of the first sub-configuration or the second sub-configuration is activated based at least in part on the group-based downlink control information message being indicative of which of the first set of resource blocks or the second set of resource blocks is activated, which of the first set of resource blocks or the second set of resource blocks is deactivated, or both.

11. The UE of claim 1, wherein the bandwidth part is associated with a plurality of layers, and wherein the plurality of layers comprises a first set of layers associated with the first sub-portion and a second set of layers associated with the second sub-portion.

12. The UE of claim 11, wherein the group-based downlink control information message is indicative of which one of the first sub-configuration or the second sub-configuration is activated based at least in part on the group-based downlink control information message being indicative of which of the first set of layers or the second set of layers is activated, which of the first set of layers or the second set of layers is deactivated, or both.

13. The UE of claim 1, wherein the bandwidth part is associated with a plurality of modulation and coding schemes, and wherein the plurality of modulation and coding schemes comprises a first set of modulation and coding schemes associated with the first sub-portion and a second set of modulation and coding schemes associated with the second sub-portion.

14. The UE of claim 13, wherein the group-based downlink control information message is indicative of which one of the first sub-configuration or the second sub-configuration is activated based at least in part on the group-based downlink control information message being indicative of which of the first set of modulation and coding schemes or the second set of modulation and coding schemes is activated, which of the first set of modulation and coding schemes or the second set of modulation and coding schemes is deactivated, or both.

15. A network entity, comprising:
one or more memories storing processor-executable code; and
one or more processors coupled with the one or more memories and individually or collectively operable to execute the code to cause the network entity to:
transmit first control signaling indicative of a configuration of a bandwidth part;
transmit second control signaling indicative of a plurality of sub-configurations associated with the bandwidth part, the plurality of sub-configurations including a first sub-configuration associated with a first sub-portion of the bandwidth part and a second sub-configuration associated with a second sub-portion of the bandwidth part, wherein the first sub-portion is different than the second sub-portion;
transmit a group-based downlink control information message indicative of which one of the first sub-configuration or the second sub-configuration is activated; and
communicate, based at least in part on the group-based downlink control information message, one or more messages in accordance with activation of one of the first sub-configuration or the second sub-configuration.

16. The network entity of claim 15, wherein the first sub-configuration is associated with a first operational state, wherein the second sub-configuration is associated with a second operational state, and wherein the group-based downlink control information message is indicative of which one of the first sub-configuration or the second sub-configuration is activated based at least in part on the group-based downlink control information message being indicative of the first operational state or the second operational state.

17. The network entity of claim 15, wherein the group-based downlink control information message is indicative of which one of the first sub-configuration or the second sub-configuration is activated based at least in part on the group-based downlink control information message being indicative of a first index associated with the first sub-configuration, a second index associated with the second sub-configuration, or both.

18. The network entity of claim 17, wherein the one or more processors are individually or collectively further operable to execute the code to cause the network entity to:
transmit an indication of table comprising associations between the plurality of sub-configurations and a plurality of indexes, including at least the first index and the second index.

19. The network entity of claim 15, wherein the one or more messages are communicated at a first time, and wherein a duration between a last symbol of a downlink control channel carrying the group-based downlink control information message and the first time satisfies a threshold duration.

20. The network entity of claim 15, wherein the one or more processors are individually or collectively further operable to execute the code to cause the network entity to:
receive a feedback message in response to the group-based downlink control information message, wherein communication of the one or more messages is based at least in part on transmission of the feedback message.

21. The network entity of claim 15, wherein the group-based downlink control information message is indicative of which one of the first sub-configuration or the second sub-configuration is activated for uplink, which one of the first sub-configuration or the second sub-configuration is activated for downlink, or both.

22. The network entity of claim 15, wherein the group-based downlink control information message is indicative of which one of the first sub-configuration or the second sub-configuration is activated based at least in part on the group-based downlink control information message being indicative of which one of the first sub-configuration or the second sub-configuration is activated, based at least in part on the group-based downlink control information message being indicative of which one of the first sub-configuration or the second sub-configuration is deactivated, or both.

23. The network entity of claim 15, wherein the bandwidth part is associated with a plurality of resource blocks, and wherein the plurality of resource blocks comprises a first set of resource blocks associated with the first sub-portion and a second set of resource blocks associated with the second sub-portion.

24. The network entity of claim 23, wherein the group-based downlink control information message is indicative of which one of the first sub-configuration or the second sub-configuration is activated based at least in part on the group-based downlink control information message being indicative of which of the first set of resource blocks or the second set of resource blocks is activated, which of the first set of resource blocks or the second set of resource blocks is deactivated, or both.

25. The network entity of claim 15, wherein the bandwidth part is associated with a plurality of layers, and wherein the plurality of layers comprises a first set of layers associated with the first sub-portion and a second set of layers associated with the second sub-portion.

26. The network entity of claim 25, wherein the group-based downlink control information message is indicative of which one of the first sub-configuration or the second sub-configuration is activated based at least in part on the group-based downlink control information message being indicative of which of the first set of layers or the second set of layers is activated, which of the first set of layers or the second set of layers is deactivated, or both.

27. The network entity of claim 15, wherein the bandwidth part is associated with a plurality of modulation and coding schemes, and wherein the plurality of modulation and coding schemes comprises a first set of modulation and coding schemes associated with the first sub-portion and a second set of modulation and coding schemes associated with the second sub-portion.

28. The network entity of claim 27, wherein the group-based downlink control information message is indicative of which one of the first sub-configuration or the second sub-configuration is activated based at least in part on the group-based downlink control information message being indicative of which of the first set of modulation and coding schemes or the second set of modulation and coding schemes is activated, which of the first set of modulation and coding schemes or the second set of modulation and coding schemes is deactivated, or both.

29. A method for wireless communications at a user equipment (UE), comprising:
receiving first control signaling indicative of a configuration of a bandwidth part;
receiving second control signaling indicative of a plurality of sub-configurations associated with the bandwidth part, the plurality of sub-configurations including a first sub-configuration associated with a first sub-portion of the bandwidth part and a second sub-configuration associated with a second sub-portion of the bandwidth part, wherein the first sub-portion is different than the second sub-portion;
receiving a group-based downlink control information message indicative of which one of the first sub-configuration or the second sub-configuration is activated; and
communicating, based at least in part on the group-based downlink control information message, one or more messages in accordance with activation of one of the first sub-configuration or the second sub-configuration.

30. A method for wireless communications at a network entity, comprising:
transmitting first control signaling indicative of a configuration of a bandwidth part;
transmitting second control signaling indicative of a plurality of sub-configurations associated with the bandwidth part, the plurality of sub-configurations including a first sub-configuration associated with a first sub-portion of the bandwidth part and a second sub-configuration associated with a second sub-portion of the bandwidth part, wherein the first sub-portion is different than the second sub-portion;
transmitting a group-based downlink control information message indicative of which one of the first sub-configuration or the second sub-configuration is activated; and
communicating, based at least in part on the group-based downlink control information message, one or more messages in accordance with activation of one of the first sub-configuration or the second sub-configuration.
